(19) United States
(12) Patent Application Publication
(10) Pub. No.: US 2014/0164167 A1
(43) Pub. Date: Jun. 12, 2014

(54) COMMERCE FACILITATION APPARATUSES, METHODS AND SYSTEMS

(71) Applicant: Timothy G. Taylor, Naples, FL (US)

(72) Inventor: Timothy G. Taylor, Naples, FL (US)

(21) Appl. No.: 14/101,121

(22) Filed: Dec. 9, 2013

Related U.S. Application Data
(60) Provisional application No. 61/735,760, filed on Dec. 11, 2012.

(51) Int. Cl. G06Q 30/06

(52) U.S. Cl. CPC G06Q 30/0611
USPC 705/26.4

(57) ABSTRACT

The COMMERCE FACILITATION APPARATUSES, METHODS AND SYSTEMS (“CF”) transform consumer service request input data via CF components into provider service confirmation messages and provider service monitoring triggers. In one implementation, a commerce facilitating system embodiment is disclosed, comprising: a processor; and a memory disposed in communication with the processor and storing processor-issuable instructions that cause the processor to generate a graphical user interface that is display via a display screen operatively connected to the processor, the user interface including a map visualization comprising: a graphical element depicting a location of a service provider; graphical elements depicting locations of a plurality of potential customers for the service provider; and a graphical element depicting a fitness for the service provider conducting commerce with one of the potential customers, compared to the other potential customers.

### CROSS-REFERENCE TO RELATED APPLICATIONS

The present patent application claims the benefit of priority to U.S. Provisional Patent Application Ser. No. 61/735,760, filed Dec. 11, 2012. The inventor of this patent application is also listed as an inventor on U.S. patent application Ser. No. 13/768,231, filed Feb. 15, 2013, and U.S. patent application Ser. No. 13/912,786. Each of the foregoing patent applications is incorporated by reference herein in its entirety for any purpose whatsoever.

### COPYRIGHT NOTICE

This application for letters patent discloses and describes various novel innovations and inventive aspects of COMMERCE FACILITATION technology 6 (hereinafter “disclosure”) and contains material that is subject to copyright, mask work, and/or other intellectual property protection. The respective owners of such intellectual property have no objection to the facsimile reproduction of the disclosure by anyone as it appears in published Patent Office file/records, but otherwise reserve all rights.

### FIELD

The present innovations generally address apparatuses, methods, and systems for facilitating trade and commerce, and more particularly, include COMMERCE FACILITATION APPARATUSES, METHODS AND SYSTEMS (“CF”).

### BACKGROUND

Consumers engage providers to deliver products and/or services for the consumers. Providers may compete against each other to provide such products and/or services for the consumers. Providers may compete across a variety of parameters (e.g., price, service quality, reliability, etc.) in the provision of the products and/or services for the consumers.

### BRIEF DESCRIPTION OF THE DRAWINGS

The accompanying appendices, drawings, figures, images, etc. illustrate various example, non-limiting, inventive aspects, embodiments, and features (“e.g.,” or “example(s)”) in accordance with the present disclosure:

FIGS. 1A-B show block diagrams illustrating example aspects of the CF;

FIGS. 2A-I show screenshots of user interface(s) of a trucking application, illustrating example aspects of the CF;

FIGS. 3A-H show screenshots of user interface(s) of a trucking application, illustrating additional example aspects of the CF;

FIGS. 4A-B show datagraph diagrams illustrating examples of transforming service request input data via a Peer-to-Peer Commerce Facilitation (“p2p-CF”) component into provider service confirmation messages and provider service monitoring triggers;

FIG. 5 shows a logic flow diagram illustrating examples of transforming parameters of commerce offers via a Commerce Offer Match Rating (“COMR”) component into offer scores and score-representative color coding notifications; and

FIG. 6 shows a block diagram illustrating example aspects of a CF controller.

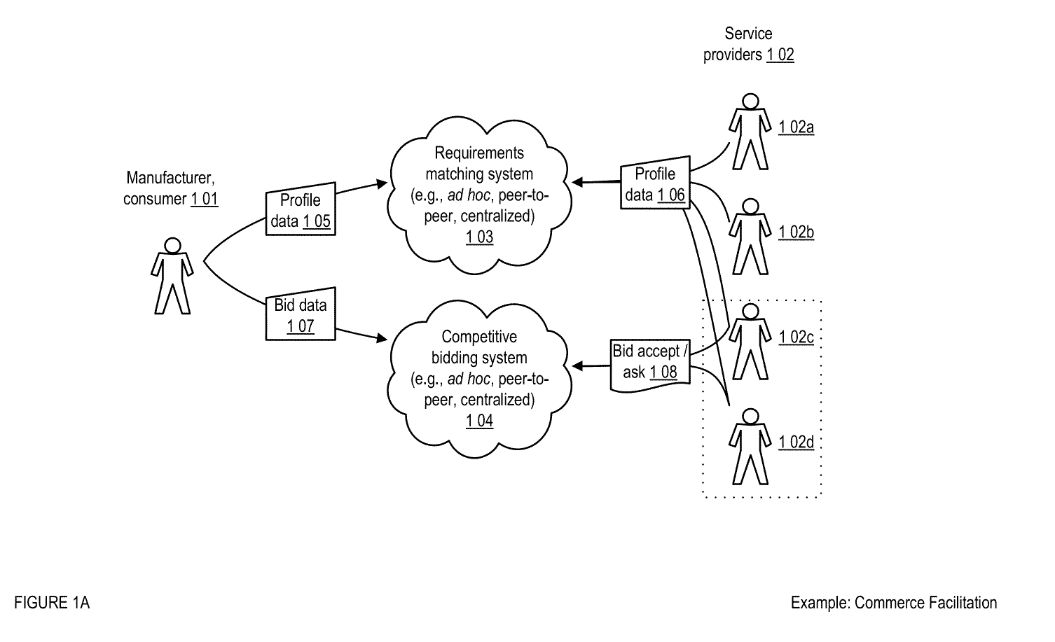

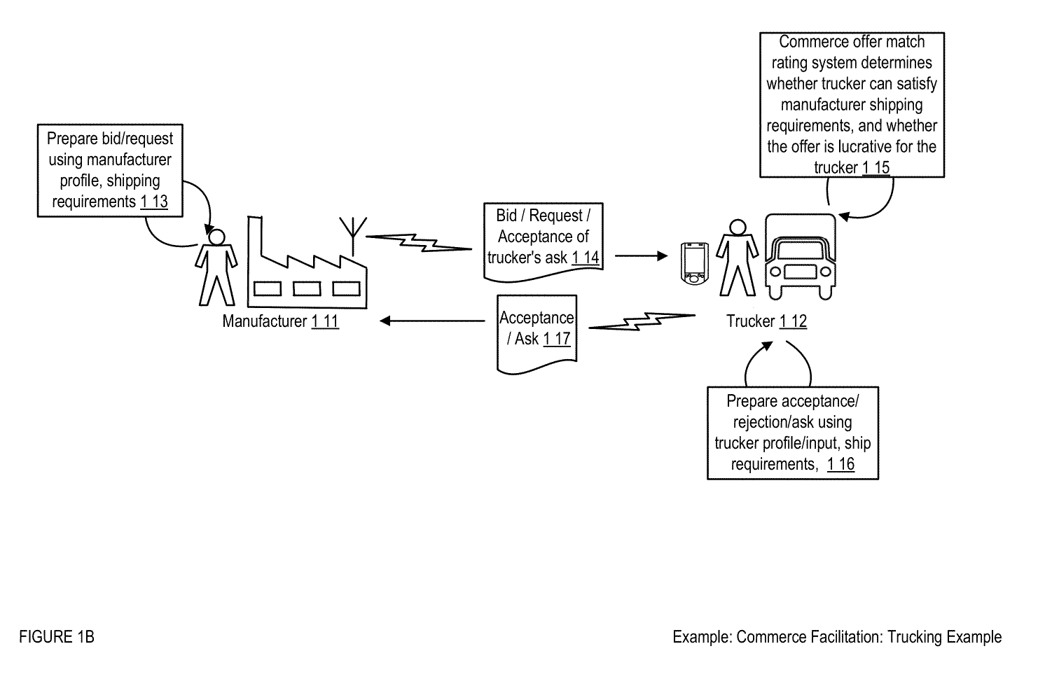

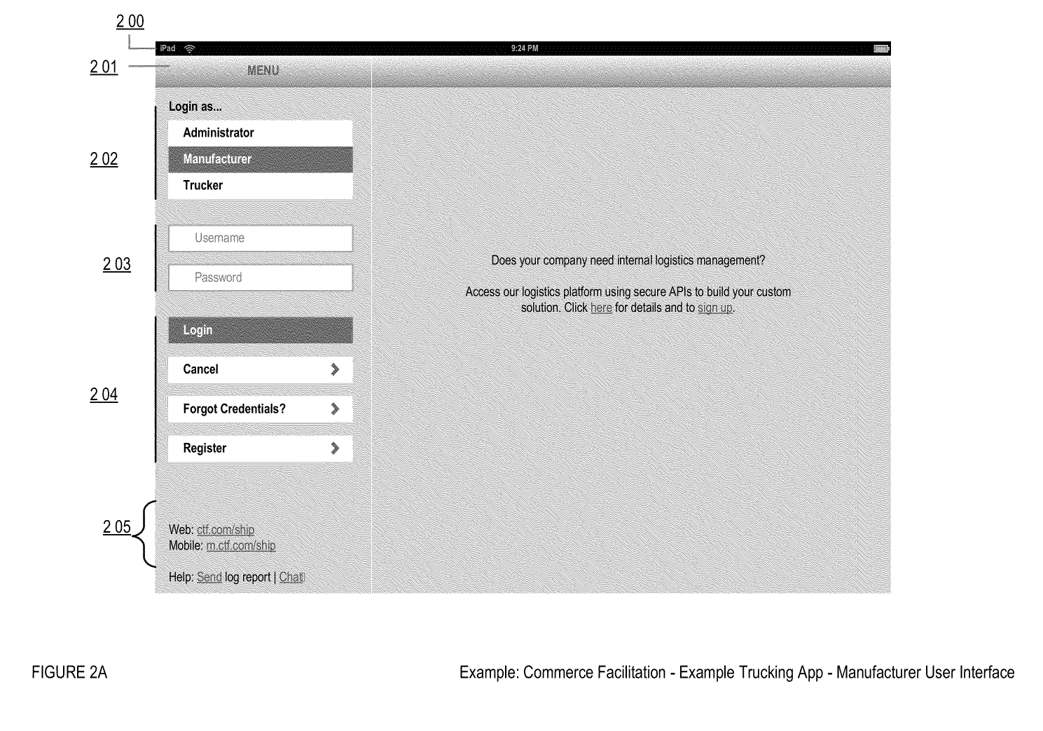

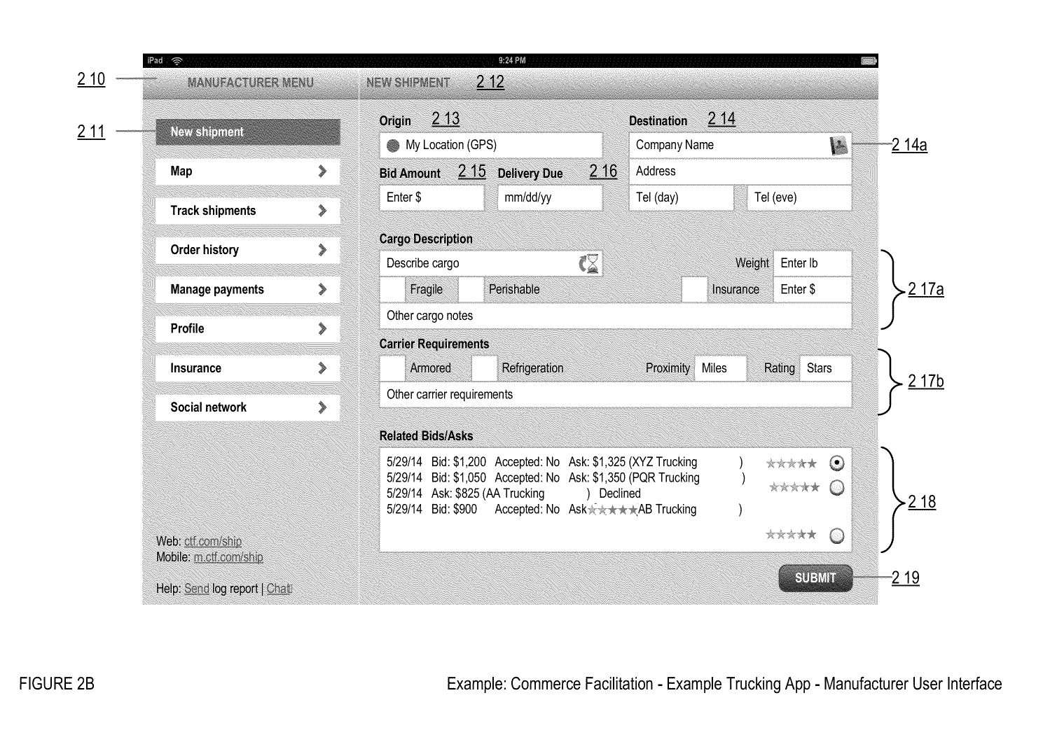

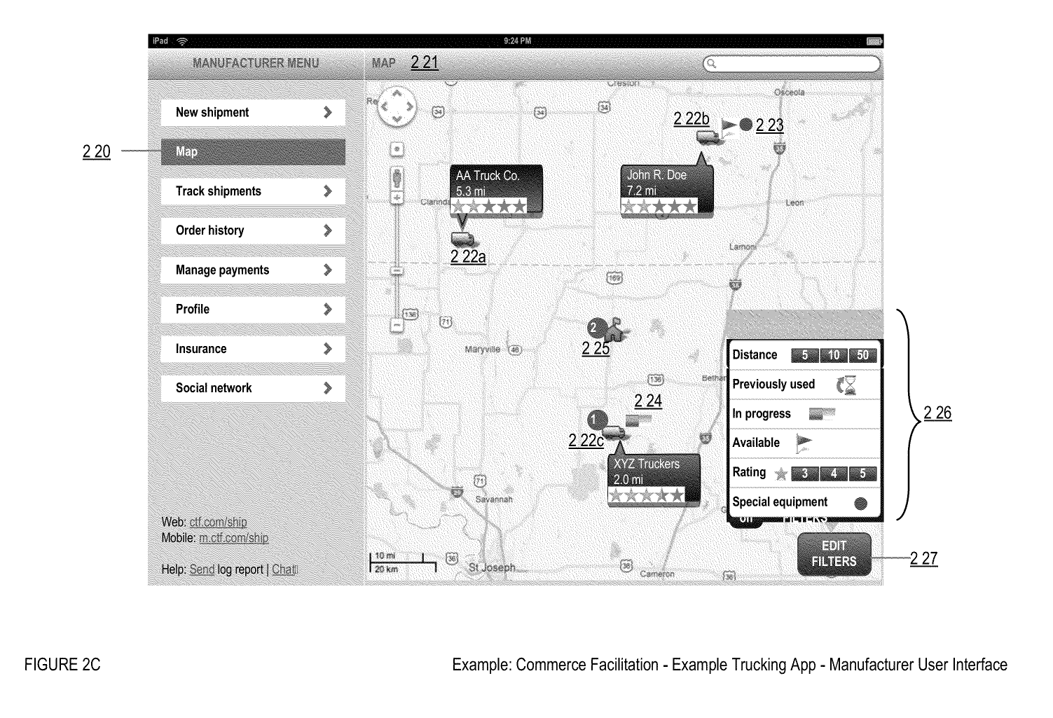

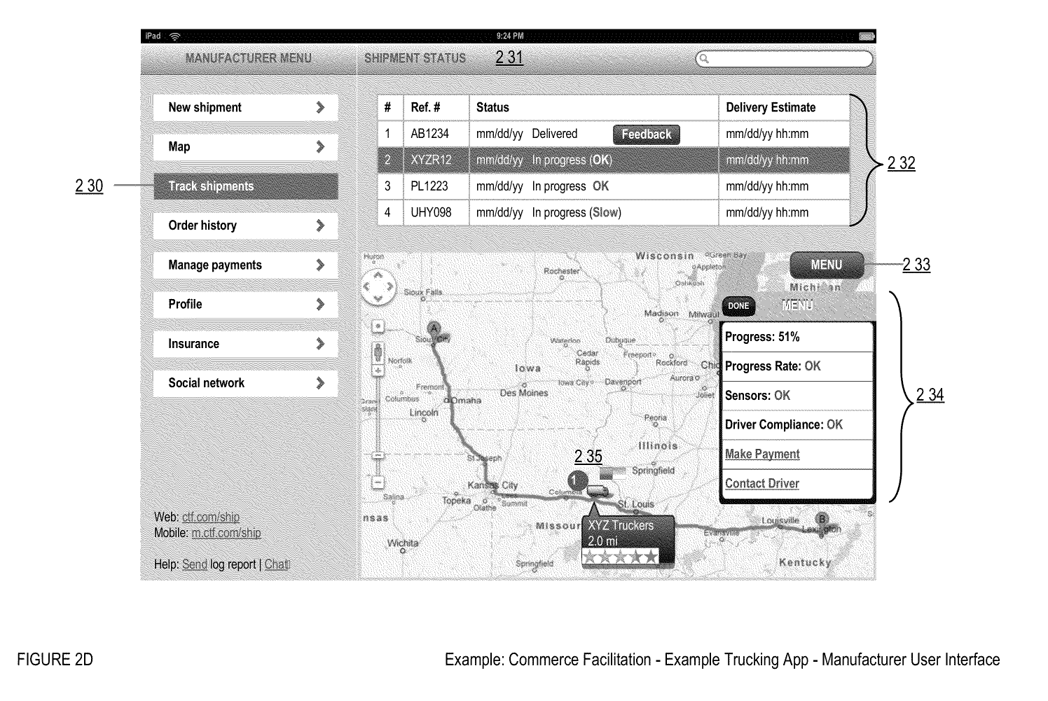

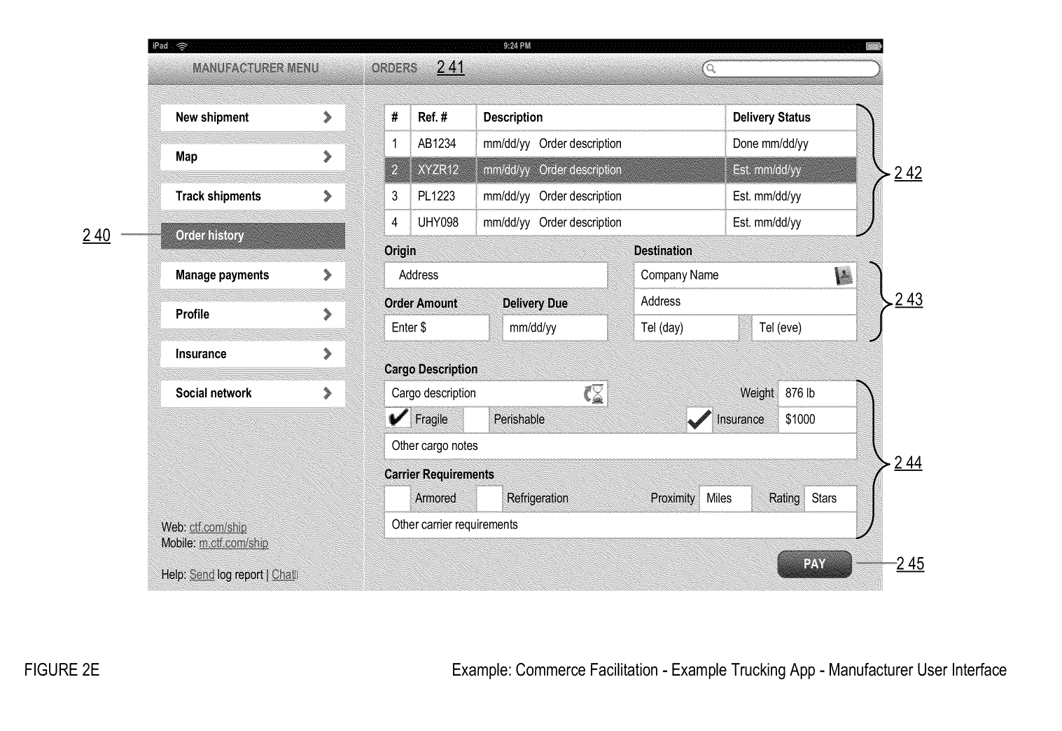

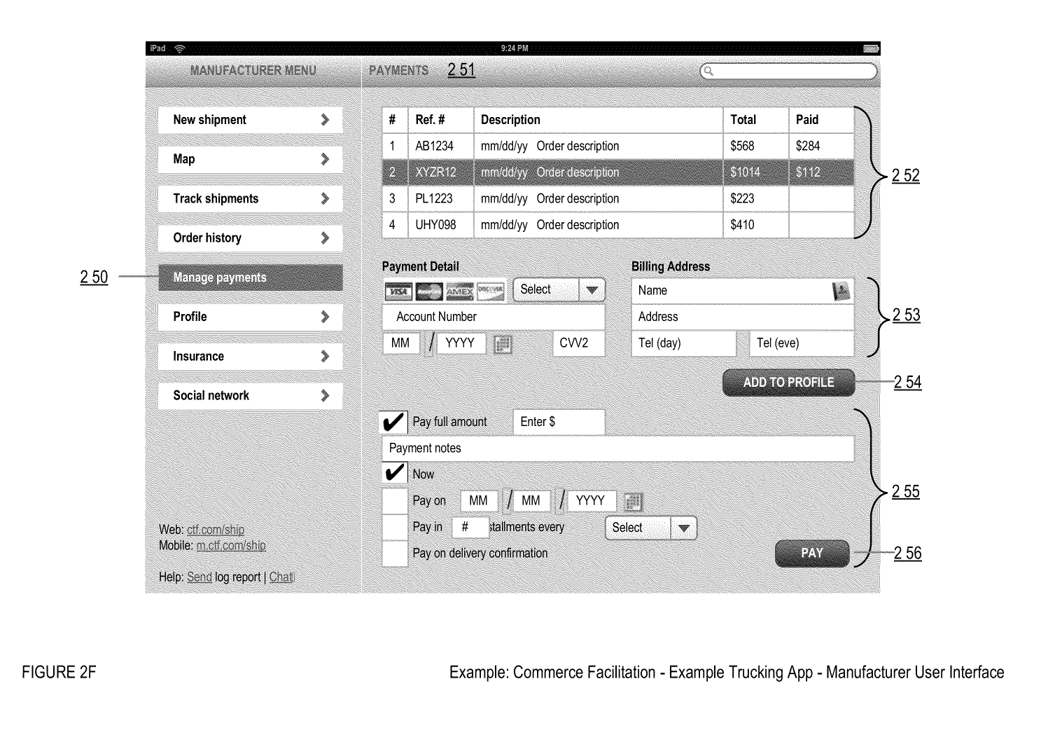

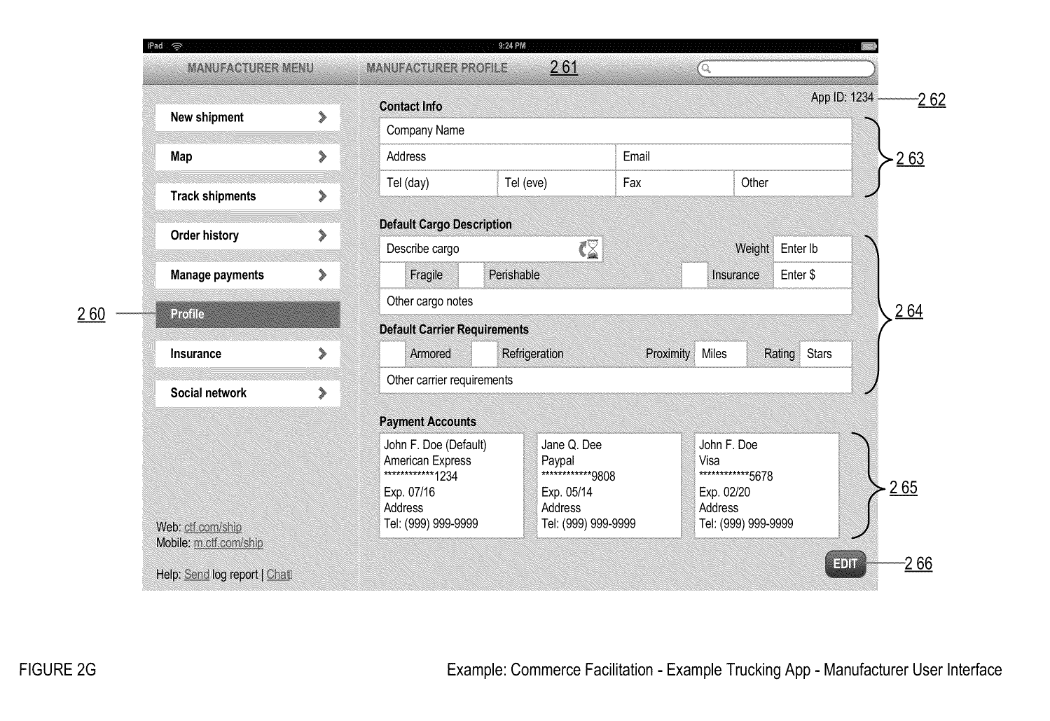

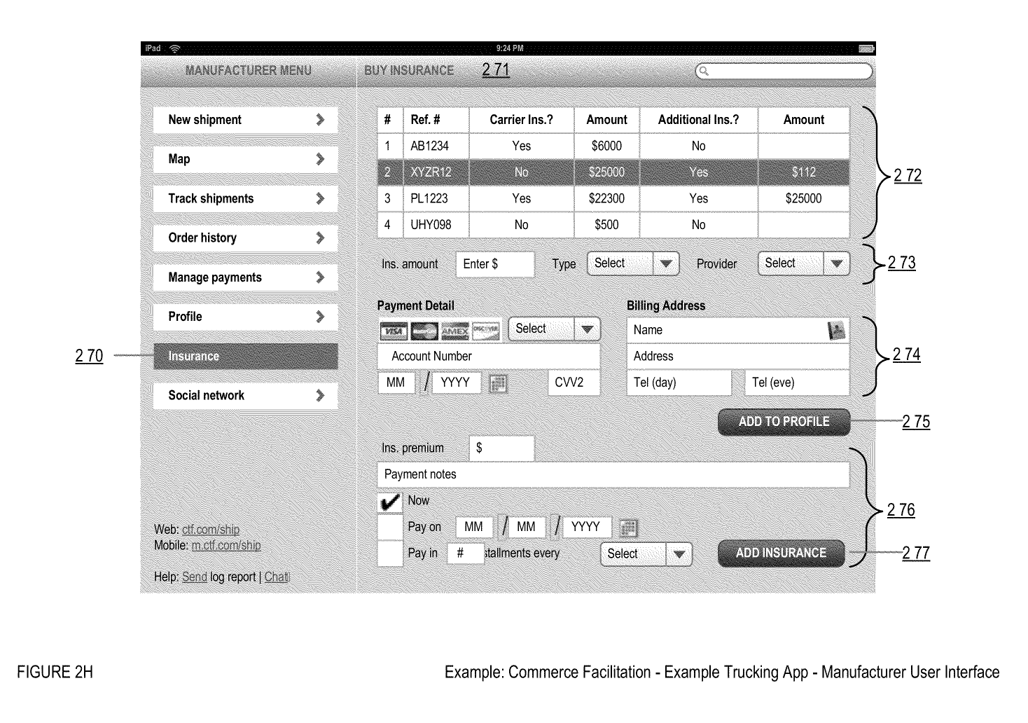

The leading number of each reference number within the drawings indicates the figure in which that reference number is introduced and/or detailed. As such, a detailed discussion of reference number 101 would be found and/or introduced in FIG. 1. Reference number 201 is introduced in FIG. 2, etc.

### DETAILED DESCRIPTION

### Commerce Facilitation (CF)

The COMMERCE FACILITATION APPARATUSES, METHODS AND SYSTEMS (hereinafter “CF”) transform consumer service request input data, via CF components, into provider service confirmation messages and provider service monitoring triggers. FIGS. 1A-B show block diagrams illustrating example aspects of the CF. With reference to FIG. 1A, in some embodiments, a manufacturer or consumer (“consumer”) 101 may desires to obtain products or services from one of a number of service providers 102. The CF may facilitate a bidding process whereby the consumer may broadcast a request for products or services to the service providers 102a-d, and they may bid against each other for the right to provide the product or service for the consumer. In some embodiments, the CF may provide a requirements matching system 103 (e.g., an ad hoc matching system, a peer-to-peer matching system, a centralized matching system) that compares the profile characteristics 105 of the consumer 101 (e.g., consumer location, type of service requested, pricing criteria, special requirements, etc.) with those of the competing service providers 106 to identify a subset of the service providers who may be well suited to provide the product or service. In some embodiments, such qualifying service providers may be able to accept the consumer's request (see bid data 107), or submit competitive bids 108 via a competitive bidding system 104 (e.g., an ad hoc system, a peer-to-peer system, a centralized system).

For example, FIG. 1B illustrates such a process in the context of a trucking example. In some embodiments, a manufacturer 111 may desire to have products shipped from one location to another. The manufacturer may prepare a bid, or request (see 113), to provide for trucking companies, or individual truck operators (see 112). The manufacturer may broadcast the bid or request 114 to a plurality of truckers in a vicinity of the manufacturer. A commerce offer match rating system (see 115) provided by the CF may determines which truckers can satisfy the manufacturer's shipping requirements, and whether the bid or request by the manufacturer represents a lucrative offer for the truckers being solicited. One or more truckers may desire to service the manufacturer's request, or may provide counter-offers if they are unsatisfied with the manufacturer's bid. The CF may allow the truckers to prepare acceptances, rejections, asks, or other communications, and provide them to the manufacturer (see 117). In some embodiments, the CF may provide analytics to help the trucker determine whether to provide an acceptance, rejection, or counter-offer to the manufacturer's bid (see 116).

For example, the CF may provide an interactive application (that can be a subscription service, for example, or a logistics management system for a large shipping company) that truckers/trucking companies and manufacturers can log into. When logged in, a manufacturer can post a load into the system (e.g., shipment to be sent to a second location). Various criteria can be specified, such as (i) deadline for delivering the load, (ii) whether load includes perishable goods, (iii) identification of manufacturer, (iv) amount that the mfr is offering for the job, (v) whether refrigeration is needed, (vi) destination for the load, (vii) quality ratings (objective or subjective) of the manufacturer (e.g., 4/5 stars), (viii) amount of insurance required to take the load, and any other pertinent criteria. When loads are posted (e.g., into a queue and/or database), a graphical user interface (“GUI”) based on a road map can be populated with the geolocation information of the jobs, and an icon can be populated into the GUI. A user logged into the system can view the screen and icons, and can pan, zoom in, and such to see who/what is logged into the system.

A trucker can use a mouse/finger touch to hover over or select the icon to bring up the details on the load. Different icons can be provided in varying colors based on different criteria. For example, red can indicate a load of significant benefit to the trucker, and cooler colors (along the spectrum) can indicate progressively less attractive loads. The criteria for setting hot to cold may include, for example: (i) the amount of compensation for moving each load, (ii) the geographic proximity of the load to the trucker, (iii) the geographic proximity of the load to the trucker's planned route, (iv) quality ratings of reliability of the manufacturers vis-à-vis payment, (v) the amount of insurance that the carrier has, and the like. The size of the icons can also be altered such that loads of particular interest can be bigger than other loads that are less interesting.

A trucker can input various criteria, such as (i) planned route, (ii) destination, (iii) amount of time trucker can travel before trucker needs to rest, (iv) amount of capacity in truck, (v) subjective rating of customers (e.g., 3 out of 5 stars), (vi) objective ratings (e.g., timeliness), (vii) present geolocation, and the like. Geolocation can be obtained from a mobile device on which the trucker is running the software. In some embodiments, variables such as time the trucker can travel before being required to rest may be automatically determined by the CF based on tracking the GPS coordinates of the truck, the ignition condition of the truck, the fuel levels, pedal positions of the truck, etc., and inferring an amount of travel the trucker has continuously engaged in at any point of time. The manufacturer, or anyone else logged into the system and given appropriate permissions, can observe the trucker data and movement, such as dispatchers and such. Manufacturers can also see a similar display of their facility and all of the truckers visible on the map that are logged into the system.

The CF may allow a trucker to issue a request to take a load based on the stated terms. The trucker can also negotiate for a higher fee by submitting a bid. Multiple truckers can bid on the same load. The higher fee can be based, for example, on promising to deliver the load more quickly, providing more reliable service, providing better safety or storage conditions of the load, or other criteria. A manufacturer can similarly select a driver to enter into an arrangement. If (additional) insurance is required to take the load, the trucker can initiate a transaction sequence with an insurance carrier to obtain additional coverage via the CF. The pertinent information of the shipment can be sent to the insurance carrier, and the carrier can accept or decline the request for insurance. The carrier can set the premium based on the inputted information by the manufacturer and trucker to gage risk of loss and set the premium accordingly. Payment can then be executed to the insurance carrier, and the carrier can issue a certificate to the manufacturer and/or trucker, as desired.

The CF may also provide analytics to ensure that, upon entering into an arrangement with the manufacturer, the truckers comply with regulations (e.g., weight limits, etc.). As an example, the GPS coordinates of the truck can be tracked over time to see how much the driver has been driving to see if he is still fresh (“hours of service validation”), and/or to determine how long it will take for the driver to refresh. The CF may track the arrangement, such as shipping delivery due, payment amounts, terms of payment, etc. since everything may be memorialized and tracked electronically, including any negotiations (e.g., bids, asks, etc.). Further, the CF may track timeliness of shipments by correlating time with geolocation of trucker.

In some embodiments, the CF may suggest loads that are fit for the trek to handle based on comparing the capabilities of the trucker and the requirements of the manufacturer, along with the bids, requests, or other estimates of profit that the trucker might be able to make either by taking on the current load, or an alternative load made available by the CF to the trucker from another manufacturer (e.g., using artificial intelligence “AI” logic to make such comparative analyses between competing offers, bid, etc.; similarly, manufacturers may also be provided such facilities to make informed decisions between competitive bids from truckers that compete on different parameters). The CF can filter out loads the driver cannot take, for example, by using criteria such as: (i) the freshness of the driver (if the load is time sensitive), (ii) liability limits of the driver's insurance, (iii) any criteria set by the driver. The CF can also account for weather predictions and actual weather on recommending loads and the like. A manufacturer can be sent a warning if it appears likely that a requested load could not be delivered, e.g., due to weather.

The CF can also provide for advance payments to the driver or payment on delivery (e.g., based on GPS coordinates being attained that correlate with the destination). Thus, the CF can be hooked into a payment execution system for a variety of purposes. In some embodiments, the transaction settlement system could be actuated by the driver taking a geocoded picture of the delivery location and submitting it to the CF to initiate a payment sequence, eliminating the need for a separate invoice. Further, the CF may utilize data provided by manufacturers and truckers to build up reviews of manufacturers and truckers over time, to inform future users of the CF in their decision-making process in a competitive marketplace.

It is to be understood that, although the capabilities of the CF are discussed herein with respect to the trucking industry, the CF's capabilities may be utilized across a wide variety of industries and contexts.

For example, in the taxi vertical, passengers and cab drivers can be logged into a similar system indicating where passengers want to go to permit cabbies/dispatchers to select passengers. Passengers can similarly select drivers. The cab drivers and passengers may negotiate agreement on the spot and pay through a virtual wallet. Passengers may input destination, and the CF may compute a fare, and populate a GUI using the fare. The size of the fare or other criteria can affect the size/color of the icon in the GUI. Reviews can be available for the cab driver or the cab itself (e.g., what was the cab ride like?, etc.).

As another example, in on-call trades, such as plumbers, electricians, etc., the CF may allow customers to sign in (e.g., via a third-party website such as “Angies's List”) and see who is nearby or on the road, and can post their job and/or select a tradesman to hire. The size of the job or other criteria can affect the size/color of the icon in the GUI. Tradesmen can be rated on hourly rate, customer satisfaction reviews, and the like. As another example, emergency workers, such as ambulances/EMT's, firefighters, police departments, etc., may utilize features of the CF to quickly identify the appropriate response team for a given situation, and provide the service in a timely fashion at minimum cost. The CF may thus facilitate commerce in any commodity, especially expiring commodities like jet charter, taxi's and trucking. However, the CF may be used to facilitate in commercial transactions in metals, food, or just about anything for sale. In sales of such commodities, the properties of the commodities may still be interpreted on a travel map for visualization purposes, to provide a person an intuitive sense of costs (visualized as time and distance on a map, but which translates to money). The CF may provide computational algorithms to convert time and distance in the interactive map into the appropriate parameter at a later time. Sizes on the map may translate to yield, profit, revenue, or similar parameters. Thus, in general, a user desiring to engage in a commercial transaction may log into the CF, make a bid or request therein (for selling something, whether it be a service or an article), and the commodity/service would then be uploaded to a map visualization. The CF may facilitate transaction concerning any type of commodity or service, and users may apply filters depending on the vertical (or industry segment) that they are interested in. That vertical would have its own type of icons (e.g., mechanics, cows, taxis, etc.), its own types of inputs, etc. The users may then initiate negotiations or purchase agreements among themselves. Thus, the CF may facilitate a wide variety of negotiations and transactions.

FIGS. 2A-I show screenshots of user interface(s) of a trucking application, illustrating example aspects of the CF. With reference to FIG. 2A, in some embodiments, the CF may provide an executable application 200, within which a user may engage with the CF and other CF users. The CF may provide a graphical user interface of facilitating commerce via a web application, a desktop application, a mobile application, and/or the like (see 205). A menu 201 may provide options for a user to log into the application. The user may log into as an administrator (e.g., to modify the app behavior for all participants), as a manufacturer, or as a trucker (see 202). The user may provide a user name and password (see 203) to log in, or if the user does not have a login, the user may register for a login to access the features of the app (see 204).

With reference to FIG. 2B, in some embodiments, upon logging into the app, the app may provide a graphical user interface (GUI) for the user. The GUI may include a menu bar 210, as well as a context frame 212. In the context of a manufacturer logging into a trucking app, the app may provide an interface wherein the manufacturer may request a new shipment 211. For example, in the new shipment frame 212, the user may provide an origin location (e.g., using global positioning system (“GPS”) coordinates) 213, a destination location 214 (e.g., selected from a contacts database—see 214a), a requested delivery date 216, and a bid amount for the service 215. In some embodiments, the user may enter a description of the cargo 217a to be shipped. For example, such description may include, without limitation, a cargo description byline, a flag indicating its fragility (e.g., glass, eggs, etc.), a flag indicating its perishability (e.g., meat, vegetables, milk, etc.), a weight for the cargo, and insurance coverage desired from the trucking company/trucker. The user may also enter any other pertinent notes for the prospective trucker. The user may provide additional cargo information 217b, including, without limitation, a flag indicating whether armor is required (e.g., for carrying sensitive documents, monetary notes, etc.), a flag indicating whether refrigeration is required, a proximity of the trucker to the manufacturer's current location, a trucker minimum rating, etc. In some embodiments, the app may provide a listing of related acceptances/rejections/bids/counter-offers (asks) made by truckers to the manufacturer's current or prior related shipment requests, 218. The user may select an ask from this list, and submit acceptance of that ask, or may provide input into the fields of the new shipment frame 212, and submit a bid for consideration by the truckers logged into the CF.

With reference to FIG. 2C, in some embodiments, either upon submitting a new shipment request, or upon activating a GUI element 220 (“map”), the app may provide an interactive map display 221 for the user. The map may provide a view of the manufacturer's location (see 225), along with truckers present in proximity to the manufacturer (see, e.g., 222a-c)). Each entity (trucker, manufacturer) may be represented by an icon (e.g., truck, factory, home, etc.). Associated with each icon, there may be additional indicators of information related to the entity represented by the icon. For example, the green flag next to the truck represented by 222b may indicate that the trucker is available for picking up a load from manufacturer represented by 225. A blue dot 223 may represent that the trucker is equipped with special equipment that the manufacturer has indicated as desired (or desirable) in the new shipment request. Next to each trucker icon may be provided a rating (e.g., via one to five stars) of the trucker, e.g., based on past performance and current capability. Similarly, shippers, manufacturers and brokers can be assigned ratings in terms, for example, as to how well truckers are treated by shippers, manufacturers and brokers, whether the manufacturer or broker make payments timely, and a loyalty rating indicating whether they are loyal to truckers, such as by the sending of repeat business to a trucker, and the like. In general, the size, color, animation, etc. of any icon may be modified to provide information to a user viewing the map visualization. For example, a large trucker icon may indicate to the manufacturer that the trucker associated with that icon is best suited to service the manufacturer's shipping request. A number enclosed within a green-colored circle may indicate the number of shipments a trucker is currently transporting (i.e., in progress) within the truck. Similarly, a number enclosed within a red-colored circle may indicate the number of shipments the manufacturer has available for transportation. In some embodiments, the user may apply filters (see 227) to obtain a view of only desirable elements within the map view. For example, the user may utilize a menu 226 to select a type of filter, and apply a value to the type of filter selected. The app may then provide a map visualization in accordance with the applied filter value.

With reference to FIG. 2D, in some embodiments, the app may allow the user to track 230 a number of shipments currently in progress. The user may select a shipment from a list of shipment 232. The app may provide a map visualization corresponding to the selected shipment. The map visualization may depict a progress of the trucker 235, and may also provide statistics on the progress of the trucker, see 233-234. For example, the statistics may include, without limitation, a progress (e.g., a %), a progress rate indicator, sensor readings on the truck, indication of driver compliance. In addition, the app may allow the manufacturer to contact the trucker, or to provide a payment to the trucker (upon completion of a phase of the trucking process).

With reference to FIG. 2E, in some embodiments, the app user may track order history 240. The app may provide a list of past orders 242, within a frame 241 within the app. The list may be sorted by any field, such as, without imitation, reference number, description, date, delivery status, price, etc. When the user selects a past order, the details of the order may be displayed by the app (see 243-244). For example, the app may depict the cargo's origin address, destination address, order amount, delivery date (or due date), cargo description, a flag indicating fragility of the items, a flag indicating perishability of the item, weight, insurance coverage, armory requirements, refrigeration requirements, current location (proximity) of the truck, a current rating for the truck, etc. The app may allow the user to make a payment towards the past order selected for display within the app (see 245).

With reference to FIG. 2F, in some embodiments, the app user may manage payments 250 to truckers from within the app. The app may provide a list of orders 252, within a frame 251 within the app. The list may be sorted by any field, such as, without imitation, reference number, description, date, delivery status, price, etc. The user may select an order, and make a payment towards the order selected for display within the app. The user may provide payment detail, including a card type, account number, account data, billing address (see 253). The user may store the payment credentials for later retrieval (see 254). The user may select a payment amount, and payment structure (e.g., in full, in installment, in automatic payments, etc.), 255, and may submit the payment for processing from directly within the app, 256.

With reference to FIG. 2G, in some embodiments, the app may store a profile 260 for the manufacturer. The profile 261 may include an app identifier 262, contact information 263, default cargo description 264, payment accounts added to the profile 265, etc. The user may modify the parameters of the user's profile at any time, 266. With reference to FIG. 2H, in some embodiments, the app may allow a user to buy insurance coverage 270 for a load. The app may provide a list of orders 272, within a frame 271 within the app. The list may be sorted by any field, such as, without imitation, reference number, description, date, delivery status, price, etc. The user may select an order, and make a payment towards insurance for the order selected for display within the app. The user may provide an insurance coverage amount, a coverage type, and a provider, 273. The user may also provide payment detail, including a card type, account number, account data, billing address (see 274). The user may store the payment credentials for later retrieval (see 275). The user may select a payment amount, and payment structure (e.g., in full, in installment, in automatic payments, etc.), 276, and may submit the payment for purchasing insurance coverage from directly within the app, 277. With reference to FIG. 2I, in some embodiments, the app may allow a user to engage in social networking 280 from within the app. The user may integrate their other social networks into the app (see 285), or may build a social network from within the app. For example, the user may utilize a social window 281 including a list of the user's contacts. The user may select a contact, e.g., 282, and engage in a conversation with the contact, 283-284.

Moreover, a map 288 can be embedded in the social networking portion of the app showing the physical location of the user's contacts 289. The user can then select a user by touching their icon, for example, on the map, and determine their status and/or to send a message to them, such as for setting up an in-person meeting for a meal, and the like. If desired, the user can select to refer a load that is present on a screen to a contact via the social networking aspects of the application by selecting “forward” on a menu associated with the icon that is associated with the load.

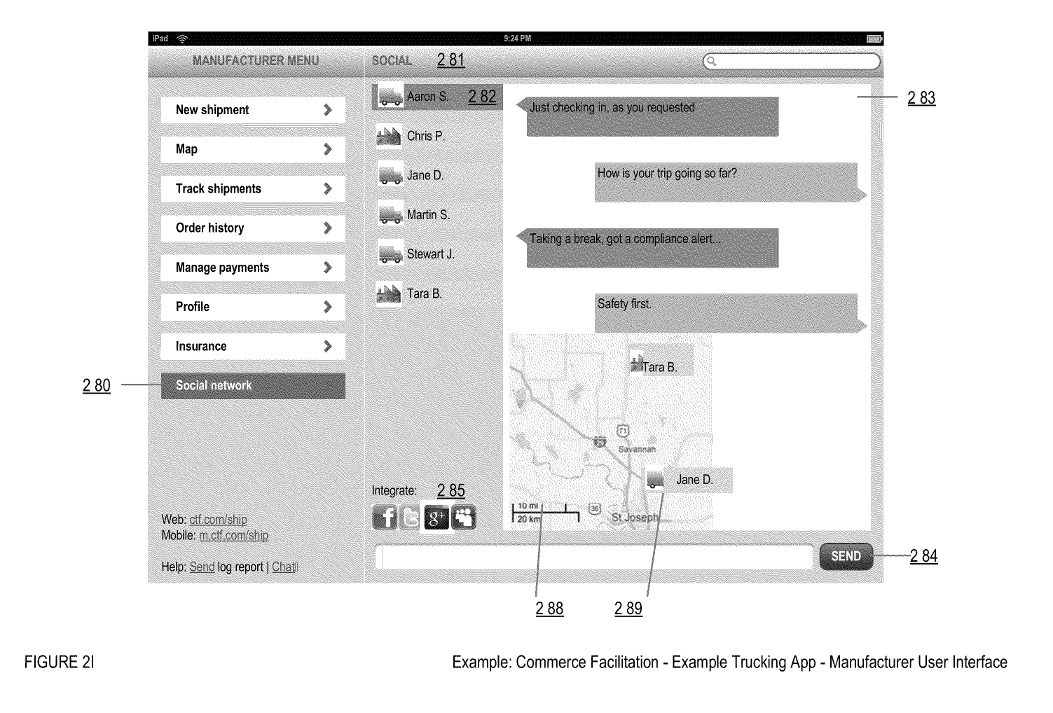

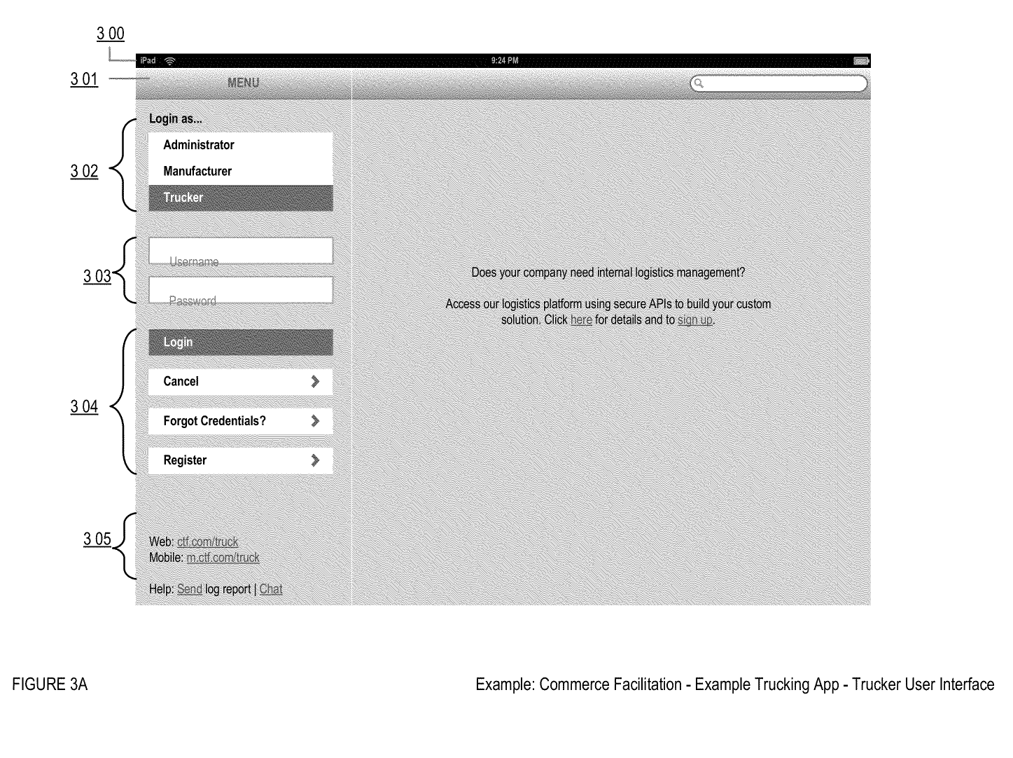

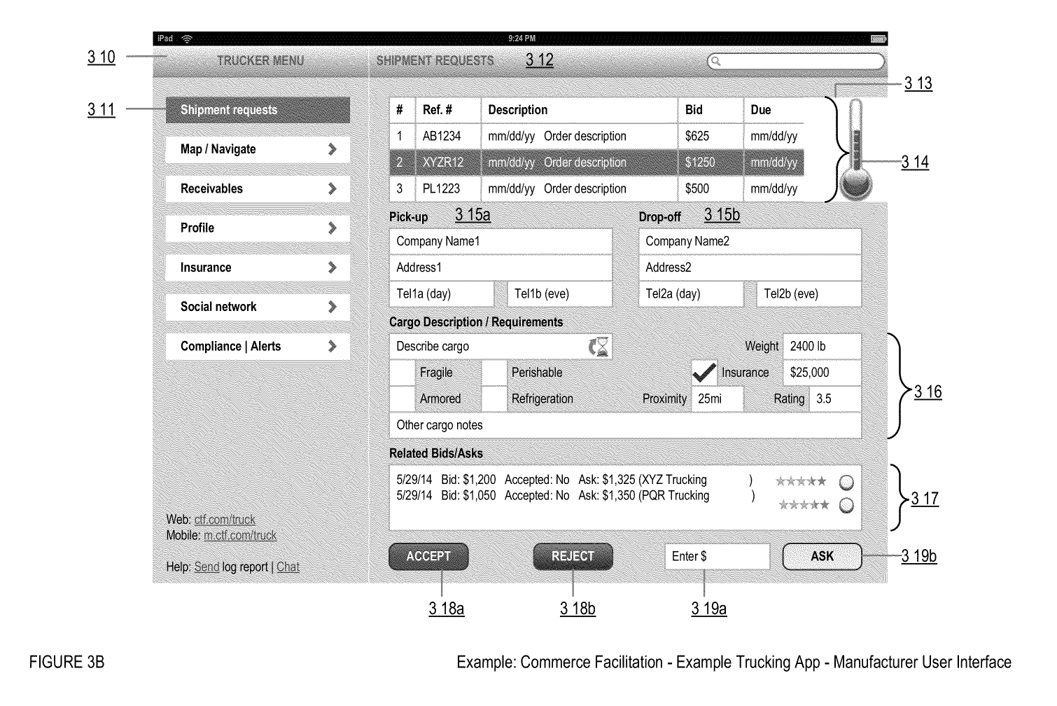

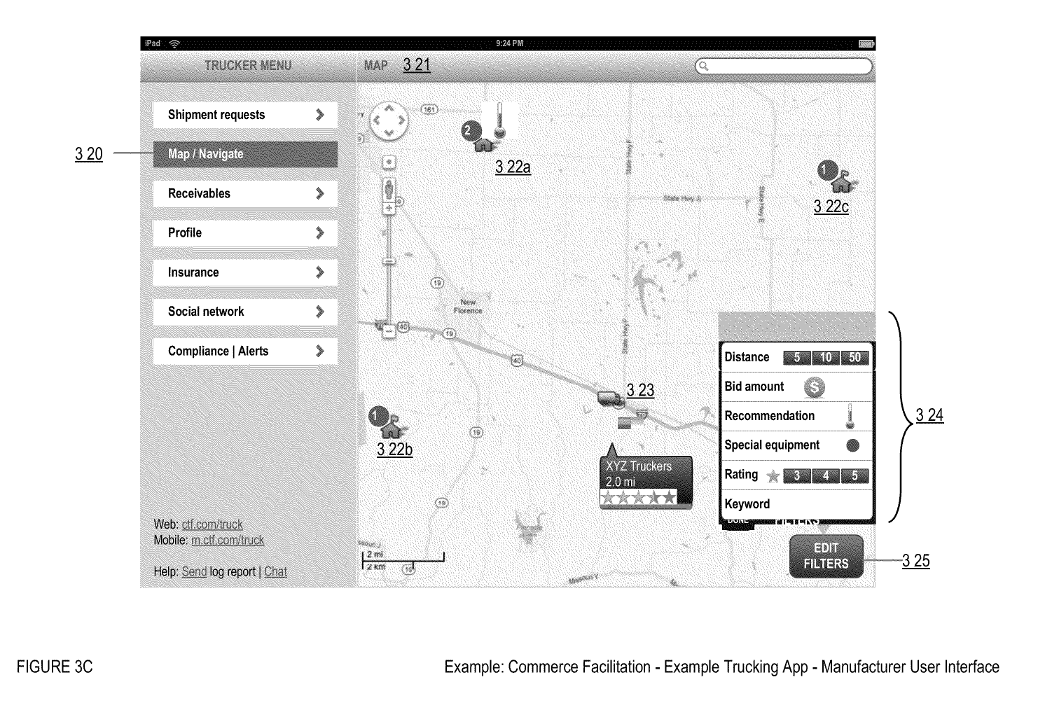

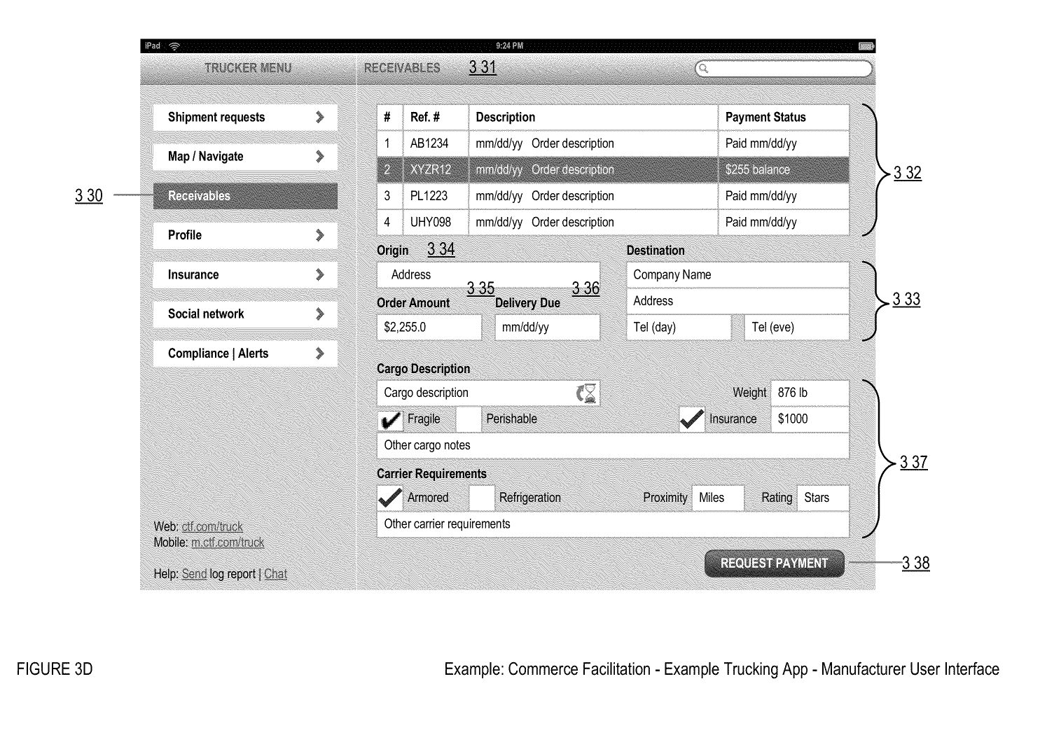

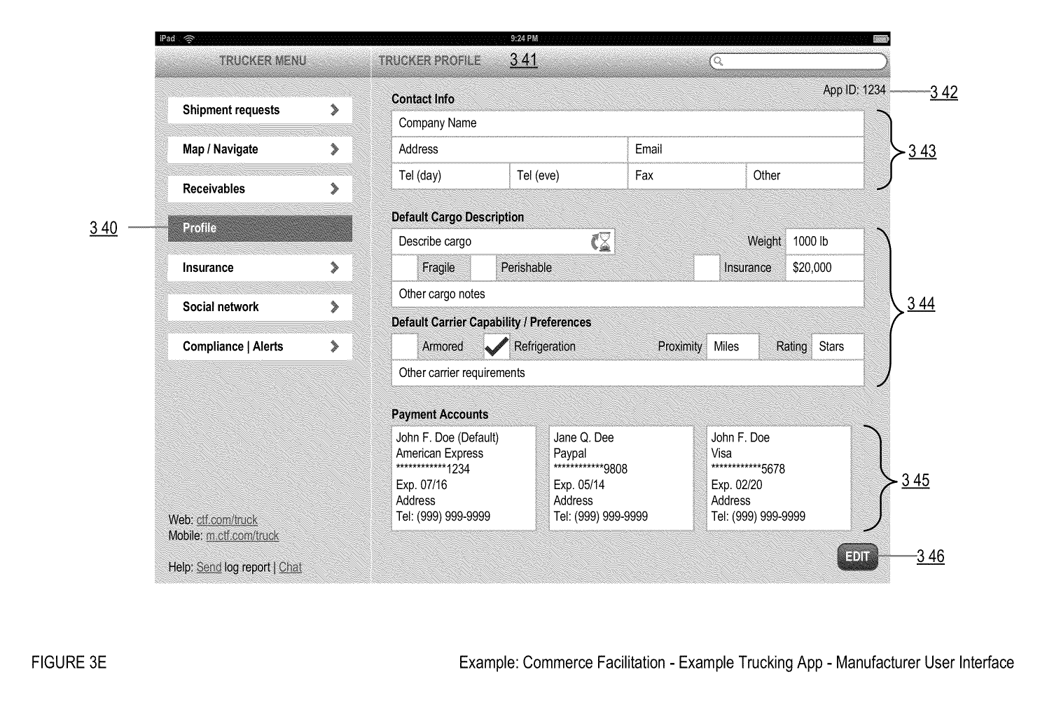

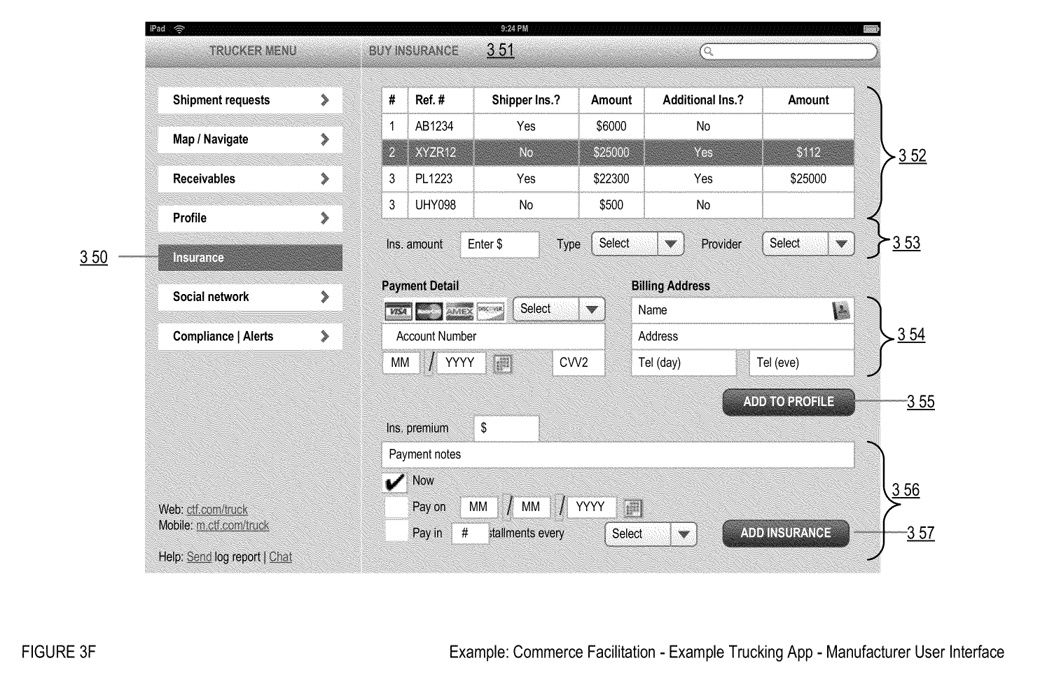

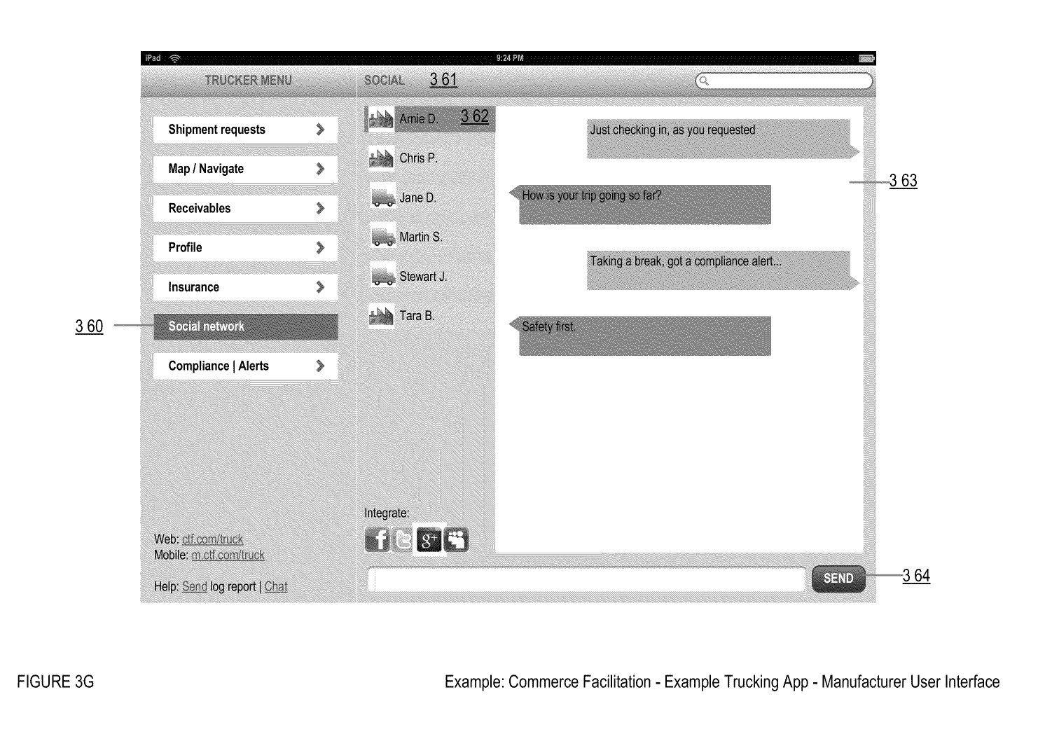

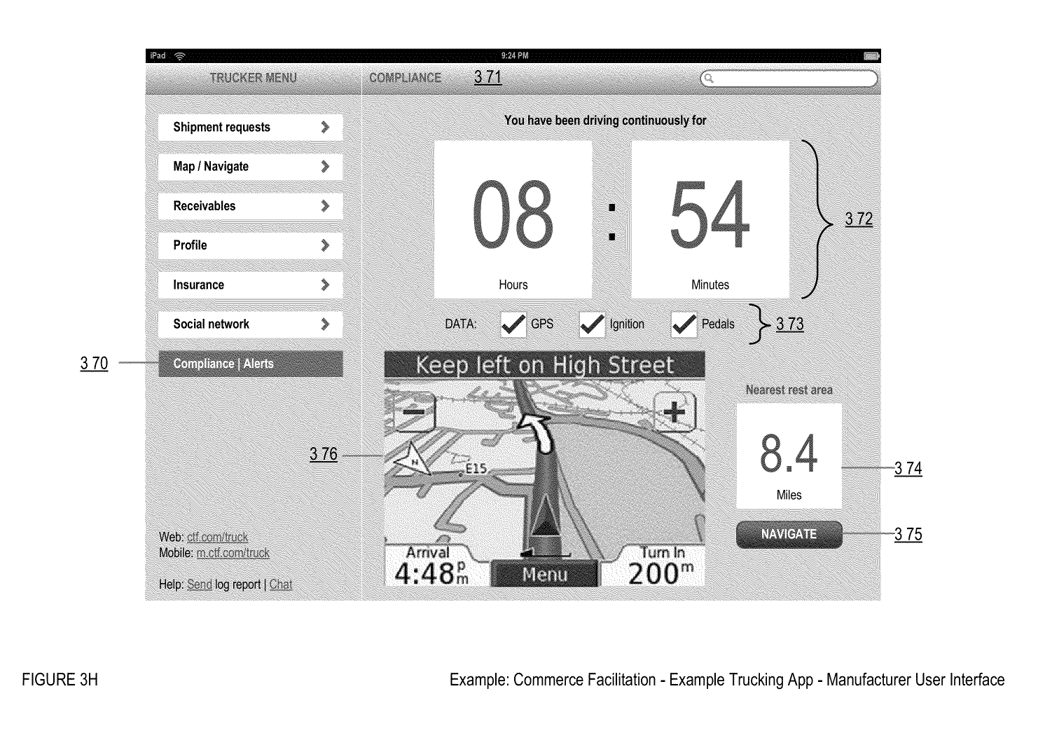

FIGS. 3A-H show screenshots of user interface(s) of a trucking application, illustrating additional example aspects of the CF. With reference to FIG. 3A, in some embodiments, the CF may provide an executable application 300, within which a user may engage with the CF and other CF users. The CF may provide a graphical user interface of facilitating commerce via a web application, a desktop application, a mobile application, and/or the like (see 305). A menu 301 may provide options for a user to log into the application. The user may log into as an administrator (e.g., to modify the app behavior for all participants), as a manufacturer, or as a trucker (see 302). The user may provide a user name and password (see 303) to log in, or if the user does not have a login, the user may register for a login to access the features of the app (see 304).

With reference to FIG. 3B, in some embodiments, upon logging into the app, the app may provide a graphical user interface (GUI) for the user. The GUI may include a menu bar 310, as well as a context frame 312. In the context of a trucker logging into a trucking app, the app may provide an interface wherein the trucker may view new shipment requests 311. For example, in the shipment requests frame 312, the user may view a list of shipment requests, 313. The user may select one of the shipment requests, and in response, the app may provide an indication of how good a fit the offer is to the trucker, 314. For example, the app may provide a color indication (e.g., red for good fit, blue for a weak fit, and shades in between for levels of fitness in between) for the user. The app may also provide an origin location 315a, a destination location 315b, a requested delivery date (see 313), and a bid amount for the service (see 313). In some embodiments, the app may provide a description of the cargo 316 to be shipped. For example, such description may include, without limitation, a cargo description byline, a flag indicating its fragility (e.g., glass, eggs, etc.), a flag indicating its perishability (e.g., meat, vegetables, milk, etc.), a weight for the cargo, and insurance coverage desired from the trucking company/trucker. The app may also provide any other pertinent notes for the prospective trucker. The app may provide additional cargo information including, without limitation, a flag indicating whether armor is required (e.g., for carrying sensitive documents, monetary notes, etc.), a flag indicating whether refrigeration is required, a proximity of the trucker to the manufacturer's current location, a trucker minimum rating, etc. In some embodiments, the app may provide a listing of related acceptances/rejections/bids/counter-offers (asks) made by truckers to the manufacturer's current or prior related shipment requests, 317. The user may select an ask from this list, and submit acceptance of that ask (see 317, 318a), or may accept the current manufacturer's bid 318a, may reject the request altogether 318b, or provide input into an ask field 319a, and submit an ask for consideration by the manufacturer.

With reference to FIG. 3C, in some embodiments, either upon accepting a new shipment request, or upon activating a GUI element 320 (“map”), the app may provide an interactive map display 321 for the user. The map may provide a view of the trucker's location (see 323), along with manufactures and truckers present in proximity to the trucker (see, e.g., 322a-c)). Each entity (trucker, manufacturer) may be represented by an icon (e.g., truck, factory, home, etc.). Associated with each icon, there may be additional indicators of information related to the entity represented by the icon. For example, a green flag next to a truck may indicate that the trucker is available for picking up a load from manufacturer. A blue dot may represent that the trucker is equipped with special equipment that the manufacturer has indicated as desired (or desirable) in the new shipment request. Next to each trucker icon may be provided a rating (e.g., via stars) of the trucker, e.g., based on past performance and current capability. In general, the size, color, animation, etc. of any icon may be modified to provide information to a user viewing the map visualization. A number enclosed within a green-colored circle may indicate the number of shipments a trucker is currently transporting (i.e., in progress) within the truck. Similarly, a number enclosed within a red-colored circle may indicate the number of shipments the manufacturer has available for transportation. In some embodiments, the user may apply filters (see 325) to obtain a view of only desirable elements within the map view. For example, the user may utilize a menu 324 to select a type of filter, and apply a value to the type of filter selected. The app may then provide a map visualization in accordance with the applied filter value.

With reference to FIG. 3D, in some embodiments, the app may allow the user to track receivables 330 for a number of shipments undertaken by the trucker. The app may provide a list of shipments 332, within a frame 331 within the app. The list may be sorted by any field, such as, without imitation, reference number, description, date, delivery status, price, etc. When the user selects a shipment, the details of the order may be displayed by the app (see 333-337). For example, the app may depict the cargo's origin address, destination address, order amount, delivery date (or due date), cargo description, a flag indicating fragility of the items, a flag indicating perishability of the item, weight, insurance coverage, armory requirements, refrigeration requirements, current location (proximity) of the truck, a current rating for the truck, etc. The app may allow the user to request a payment towards the shipment selected for display within the app (see 338).

With reference to FIG. 3E, in some embodiments, the app may store a profile 340 for the trucker. The profile 341 may include an app identifier 342, contact information 343, default cargo description 344, payment accounts added to the profile 345, etc. The user may modify the parameters of the user's profile at any time, 346. With reference to FIG. 3F, in some embodiments, the app may allow a user to buy insurance coverage 350 for a load. The app may provide a list of orders 352, within a frame 351 within the app. The list may be sorted by any field, such as, without imitation, reference number, description, date, delivery status, price, etc. The user may select an order, and make a payment towards insurance for the order selected for display within the app. The user may provide an insurance coverage amount, a coverage type, and a provider, 353. The user may also provide payment detail, including a card type, account number, account data, billing address (see 354). The user may store the payment credentials for later retrieval (see 355). The user may select a payment amount, and payment structure (e.g., in full, in installment, in automatic payments, etc.), 356, and may submit the payment for purchasing insurance coverage from directly within the app, 357. With reference to FIG. 3G, in some embodiments, the app may allow a user to engage in social networking 360 from within the app. The user may integrate their other social networks into the app (see 365), or may build a social network from within the app. For example, the user may utilize a social window 361 including a list of the user's contacts. The user may select a contact, e.g., 362, and engage in a conversation with the contact, 363-364.

With reference to FIG. 3H, in some embodiments, the app may provide compliance alerts 370 to the trucker using the app. Within a compliance frame 371, the app may display an amount of time for which the trucker has been driving continuously, 372. The app may obtain such information from GPS, the truck's ignition condition, the truck's pedal conditions, etc., 373. The app may provide an indication of proximity of the nearest rest area 374, and may include a GUI element to trigger navigation of the truck to that rest area, 375. Upon selection of the navigation button 375, the app may provide turn-by-turn directions via a display 376 within the app.

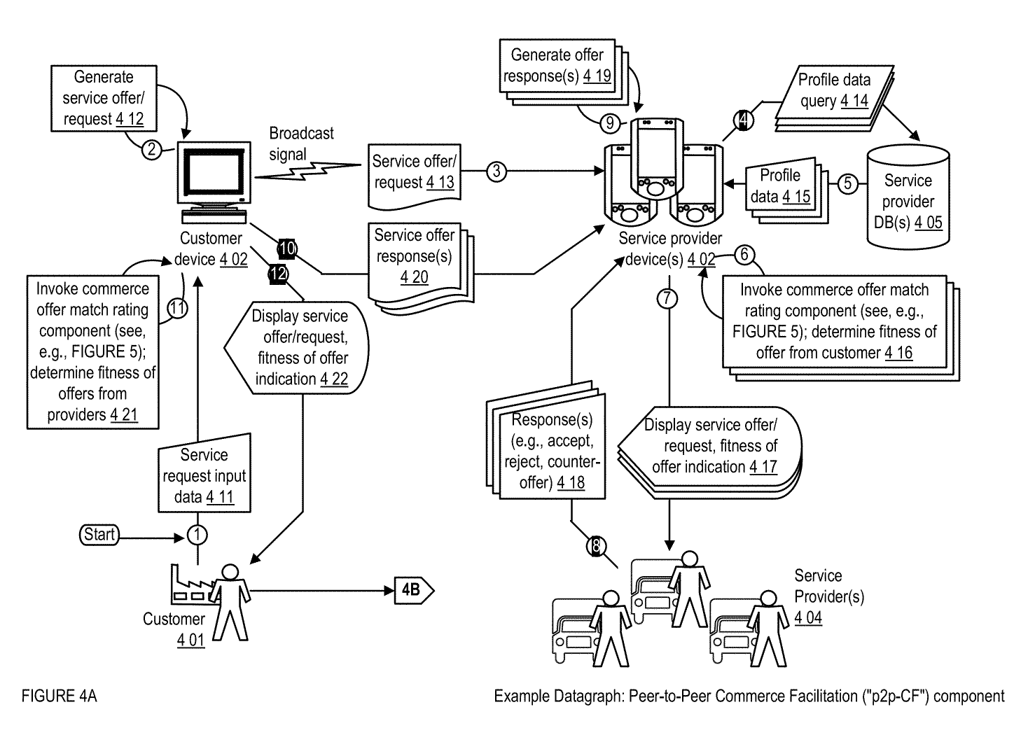

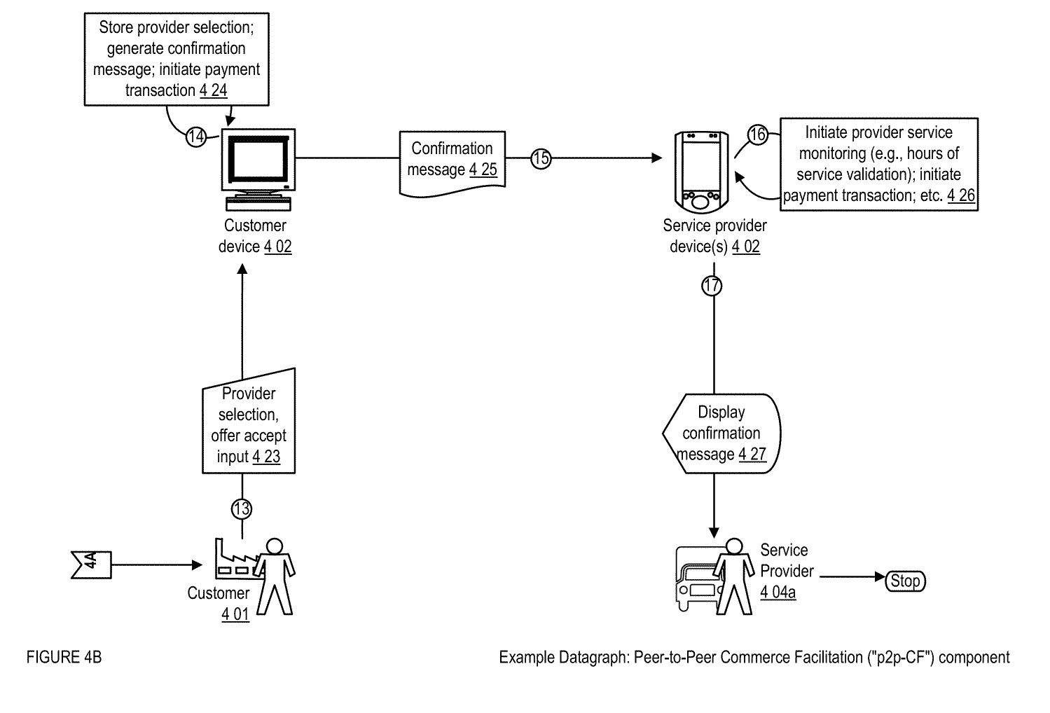

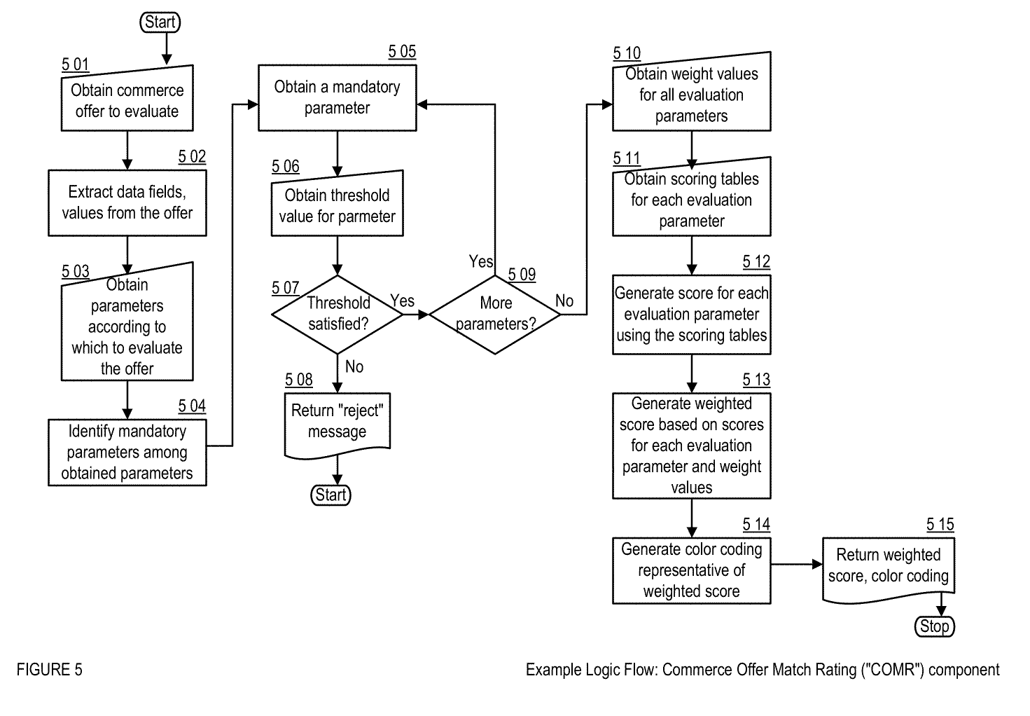

FIGS. 4A-B show datagraph diagrams illustrating examples of transforming service request input data via a Peer-to-Peer Commerce Facilitation (“p2p-CF”) component into provider service confirmation messages and provider service monitoring triggers. In some embodiments, a user 401 may desire to obtain a product or service from a service provider. The user may provide service request input data 411 into a customer device 402. In various embodiments, the user input may include, but not be limited to: a single tap of a touchscreen interface, keyboard entry, card swipe, activating a RFID/NFC equipped hardware device (e.g., electronic card having multiple accounts, smartphone, tablet, etc.) within the user device, mouse clicks, depressing buttons on a joystick/game console, voice commands, single/multi-touch gestures on a touch-sensitive interface, touching user interface elements on a touch-sensitive display, and/or the like. The customer device may generate a service offer/request, 412. For example, the service offer request may take the form of a HTTP(S) POST message including XML data comprising, e.g., the fields depicted in FIG. 2B. The customer device may broadcast the generated service/offer request 413 to a plurality of service provider devices 402, of service providers 404. Each service provider device may attempt to determine whether the request received is one that would be a good fit for the trucker to undertake. Each service provider device may query, 414-415 a service provider database 405 for a profile of the service provider. For example, the database may provide the fields included in FIG. 3E to the service provider devices. Using the received request and the profile data, the service provider devices may each invoke a commerce offer match rating component (see, e.g., FIG. 5), and may utilize the component to determine the fitness of the offer from the customer, 416. The service providers devices may display the service offer/request, and the fitness of offer indication 417 to the service providers 404. In response, the service providers may accept, reject outright, or provide counter-offers input 418 to the service provider devices. The service provider devices may generate offer responses 419 using the input from the service providers, and provide the responses to the customer device 420. In response, the customer device may optionally invoke a commerce offer match rating component (see, e.g., FIG. 5) to determine which of the offers is the best match for the customer, 421. The customer device may display 422 the results of this computation to the customer 401. With reference to FIG. 4B, the customer may select one of the offers by one of the providers to accept, and may provide an indication of the selection to the customer device, 423. The customer device may store the user's selection, generate a confirmation message for the selected service provider, and may optionally initiate a payment transaction if necessary to formalize the agreement between the customer and the service provider, 424. The customer device may provide a confirmation message 425 to the service provider device of the selected service provider. In response, the service provider device may initiate provider service monitoring (e.g., “hours of service” validation, as discussed above in the description with reference to FIG. 3G), or may initiate a payment transaction (e.g., if the customer device provided payment details to the service provider device). The service provider device may also provide a display confirmation to the service provider, 427.

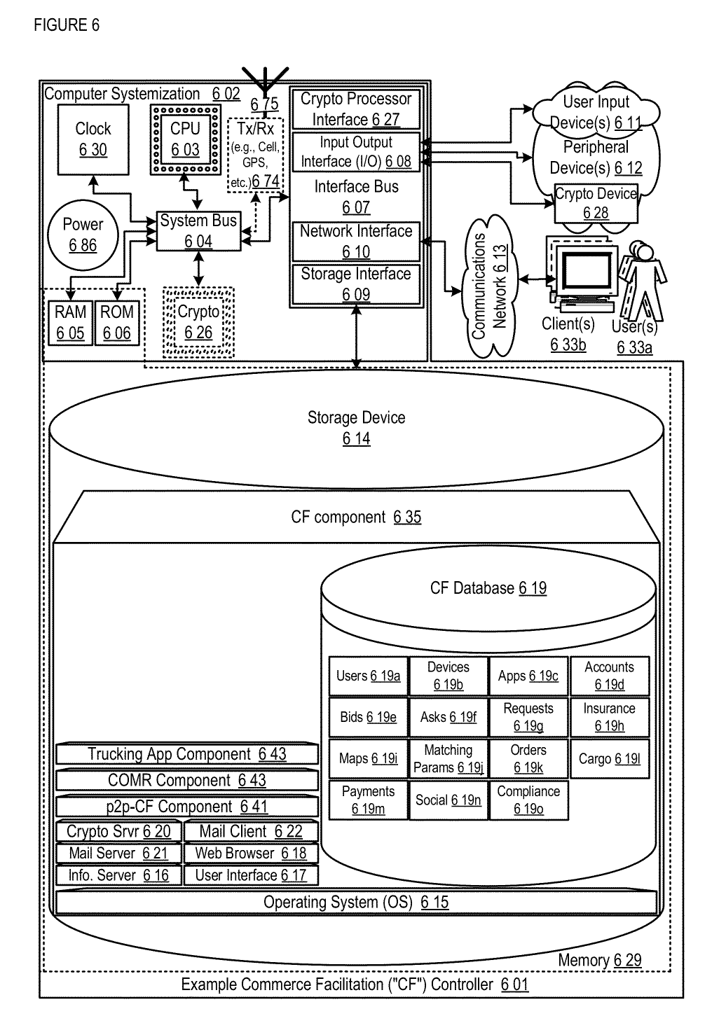

FIG. 5 shows a logic flow diagram illustrating examples of transforming parameters of commerce offers via a Commerce Offer Match Rating (“COMR”) component into offer scores and score-representative color coding notifications. In some embodiments, the CF may obtain a commerce offer to evaluate, 501. The CF may extract data fields from the offer for evaluation, 502. For example, the CF may utilize a parser similar to the example parsers discussed below in the description with reference to FIG. 6. The CF may obtain parameters according to which to evaluate the offer. For example, such parameters may include, without limitation, revenue, profit margin, proximity, insurance requirements, service provider requirements, etc. Example of such parameters include all the data fields depicted in FIGS. 2A-3H. The CF may determine which of the parameters among the obtained parameters are mandatory, e.g., where the offer cannot be accepted if the parameter requirements are not satisfied, 504. The CF may select a mandatory parameter, 505, and obtain a threshold value for that parameter that must be crossed for the parameter requirement to be satisfied, 506. If the threshold is satisfied, 507, option “Yes,” the CF may check another mandatory parameter, until there are no further mandatory parameters, see 509. If any mandatory parameter requirement is not satisfied, the CF may return a “reject” message rejecting the offer, 508. If all mandatory parameters are satisfied, 509, option “No,” the CF may obtain weight values for all evaluation parameters, 510. The CF may obtain scoring tables for each such evaluation parameter, 511, and may generate a score for each evaluation parameter using the scoring tables, 512. The CF may utilize the scores for each evaluation parameter, as well as the weight values for the evaluation parameters, to generate a weighted score, 513. The CF may also generate a color coding indicative of the weighted score (e.g., red for high weighted score, indicating that the offer is a very good fit; blue for low weighted score, indicating that the offer is not a very good fit). The CF may return the weighted score, as well as the color coding in response to the commerce offer to evaluate, 515.

### CF Controller

FIG. 6 shows a block diagram illustrating example aspects of a CF controller 601. In this embodiment, the CF controller 601 may serve to aggregate, process, store, search, serve, identify, instruct, generate, match, and/or facilitate interactions with a computer through various technologies, and/or other related data.

Users, e.g., 633a, which may be people and/or other systems, may engage information technology systems (e.g., computers) to facilitate information processing. In turn, computers employ processors to process information; such processors 603 may be referred to as central processing units (CPU). One form of processor is referred to as a microprocessor. CPUs use communicative circuits to pass binary encoded signals acting as instructions to enable various operations. These instructions may be operational and/or data instructions containing and/or referencing other instructions and data in various processor accessible and operable areas of memory 629 (e.g., registers, cache memory, random access memory, etc.). Such communicative instructions may be stored and/or transmitted in batches (e.g., batches of instructions) as programs and/or data components to facilitate desired operations. These stored instruction codes, e.g., programs, may engage the CPU circuit components and other motherboard and/or system components to perform desired operations. One type of program is a computer operating system, which, may be executed by CPU on a computer; the operating system enables and facilitates users to access and operate computer information technology and resources. Some resources that may be employed in information technology systems include: input and output mechanisms through which data may pass into and out of a computer; memory storage into which data may be saved; and processors by which information may be processed. These information technology systems may be used to collect data for later retrieval, analysis, and manipulation, which may be facilitated through a database program. These information technology systems provide interfaces that allow users to access and operate various system components.

In one embodiment, the CF controller 601 may be connected to and/or communicate with entities such as, but not limited to: one or more users from user input devices 611; peripheral devices 612; an optional cryptographic processor device 628; and/or a communications network 613. For example, the CF controller 601 may be connected to and/or communicate with users, e.g., 633a, operating client device(s), e.g., 633b, including, but not limited to, personal computer(s), server(s) and/or various mobile device(s) including, but not limited to, cellular telephone(s), smartphone(s) (e.g., iPhone®, Blackberry®, Android OS-based phones etc.), tablet computer(s) (e.g., Apple iPad™, HP Slate™, Motorola Xoom™, etc.), eBook reader(s) (e.g., Amazon Kindle™, Barnes and Noble's Nook™ eReader, etc.), laptop computer(s), notebook(s), netbook(s), gaming console(s) (e.g., XBOX Live™, Nintendo® DS, Sony PlayStation® Portable, etc.), portable scanner(s), and/or the like.

Networks are commonly thought to comprise the interconnection and interoperation of clients, servers, and intermediary nodes in a graph topology. It should be noted that the term “server” as used throughout this application refers generally to a computer, other device, program, or combination thereof that processes and responds to the requests of remote users across a communications network. Servers serve their information to requesting “clients.” The term “client” as used herein refers generally to a computer, program, other device, user and/or combination thereof that is capable of processing and making requests and obtaining and processing any responses from servers across a communications network. A computer, other device, program, or combination thereof that facilitates, processes information and requests, and/or furthers the passage of information from a source user to a destination user is commonly referred to as a “node.” Networks are generally thought to facilitate the transfer of information from source points to destinations. A node specifically tasked with furthering the passage of information from a source to a destination is commonly called a “router.” There are many forms of networks such as Local Area Networks (LANs), Pico networks, Wide Area Networks (WANs), Wireless Networks (WLANs), etc. For example, the Internet is generally accepted as being an interconnection of a multitude of networks whereby remote clients and servers may access and interoperate with one another.

The CF controller 601 may be based on computer systems that may comprise, but are not limited to, components such as: a computer systemization 602 connected to memory 629.

### Computer Systemization

A computer systemization 602 may comprise a clock 630, central processing unit (“CPU(s)” and/or “processor(s)” (these terms are used interchangeably throughout the disclosure unless noted to the contrary)) 603, a memory 629 (e.g., a read only memory (ROM) 606, a random access memory (RAM) 605, etc.), and/or an interface bus 607, and most frequently, although not necessarily, are all interconnected and/or communicating through a system bus 604 on one or more (mother)board(s) 602 having conductive and/or otherwise transportive circuit pathways through which instructions (e.g., binary encoded signals) may travel to effectuate communications, operations, storage, etc. The computer systemization may be connected to a power source 686; e.g., optionally the power source may be internal. Optionally, a cryptographic processor 626 and/or transceivers (e.g., ICs) 674 may be connected to the system bus. In another embodiment, the cryptographic processor and/or transceivers may be connected as either internal and/or external peripheral devices 612 via the interface bus I/O. In turn, the transceivers may be connected to antenna(s) 675, thereby effectuating wireless transmission and reception of various communication and/or sensor protocols; for example the antenna(s) may connect to: a Texas Instruments WiLink WL1283 transceiver chip (e.g., providing 802.11n, Bluetooth 3.0, FM, global positioning system (GPS) (thereby allowing CF controller to determine its location)); Broadcom BCM4329FKUBG transceiver chip (e.g., providing 802.11n, Bluetooth 2.1+EDR, FM, etc.), BCM28150 (HSPA+) and BCM2076 (Bluetooth 4.0, GPS, etc.); a Broadcom BCM4750IUB8 receiver chip (e.g., GPS); an Infineon Technologies X-Gold 618-PMB9800 (e.g., providing 2G/3G HSDPA/HSUPA communications); Intel's XMM 7160 (LTE & DC-HSPA), Qualcom's CDMA(2000), Mobile Data/Station Modem, Snapdragon; and/or the like. The system clock may have a crystal oscillator and generates a base signal through the computer systemization's circuit pathways. The clock may be coupled to the system bus and various clock multipliers that will increase or decrease the base operating frequency for other components interconnected in the computer systemization. The clock and various components in a computer systemization drive signals embodying information throughout the system. Such transmission and reception of instructions embodying information throughout a computer systemization may be referred to as communications. These communicative instructions may further be transmitted, received, and the cause of return and/or reply communications beyond the instant computer systemization to: communications networks, input devices, other computer systemizations, peripheral devices, and/or the like. It should be understood that in alternative embodiments, any of the above components may be connected directly to one another, connected to the CPU, and/or organized in numerous variations employed as exemplified by various computer systems.

The CPU comprises at least one high-speed data processor adequate to execute program components for executing user and/or system-generated requests. Often, the processors themselves will incorporate various specialized processing units, such as, but not limited to: floating point units, integer processing units, integrated system (bus) controllers, logic operating units, memory management control units, etc., and even specialized processing sub-units like graphics processing units, digital signal processing units, and/or the like. Additionally, processors may include internal fast access addressable memory, and be capable of mapping and addressing memory 629 beyond the processor itself; internal memory may include, but is not limited to: fast registers, various levels of cache memory (e.g., level 1, 2, 3, etc.), RAM, etc. The processor may access this memory through the use of a memory address space that is accessible via instruction address, which the processor can construct and decode allowing it to access a circuit path to a specific memory address space having a memory state/value. The CPU may be a microprocessor such as: AMD's Athlon, Duron and/or Opteron; ARM's classic (e.g., ARM7/9/11), embedded (Coretx-M/R), application (Cortex-A), embedded and secure processors; IBM and/or Motorola's DragonBall and PowerPC; IBM's and Sony's Cell processor; Intel's Atom, Celeron (Mobile), Core (2/Duo/i3/i5/i7), Itanium, Pentium, Xeon, and/or XScale; and/or the like processor(s). The CPU interacts with memory through instruction passing through conductive and/or transportive conduits (e.g., (printed) electronic and/or optic circuits) to execute stored instructions (i.e., program code). Such instruction passing facilitates communication within the CF controller and beyond through various interfaces. Should processing requirements dictate a greater amount speed and/or capacity, distributed processors (e.g., Distributed CF), mainframe, multi-core, parallel, and/or super-computer architectures may similarly be employed. Alternatively, should deployment requirements dictate greater portability, smaller mobile devices (e.g., smartphones, Personal Digital Assistants (PDAs), etc.) may be employed.

Depending on the particular implementation, features of the CF may be achieved by implementing a microcontroller such as CAST's R8051 XC2 microcontroller; Intel's MCS 51 (i.e., 8051 microcontroller); and/or the like. Also, to implement certain features of the CF, some feature implementations may rely on embedded components, such as: Application-Specific Integrated Circuit (“ASIC”), Digital Signal Processing (“DSP”), Field Programmable Gate Array (“FPGA”), and/or the like embedded technology. For example, any of the CF component collection (distributed or otherwise) and/or features may be implemented via the microprocessor and/or via embedded components; e.g., via ASIC, coprocessor, DSP, FPGA, and/or the like. Alternately, some implementations of the CF may be implemented with embedded components that are configured and used to achieve a variety of features or signal processing.

Depending on the particular implementation, the embedded components may include software solutions, hardware solutions, and/or some combination of both hardware/software solutions. For example, CF features discussed herein may be achieved through implementing FPGAs, which are a semiconductor devices containing programmable logic components called “logic blocks”, and programmable interconnects, such as the high performance FPGA Virtex series and/or the low cost Spartan series manufactured by Xilinx. Logic blocks and interconnects can be programmed by the customer or designer, after the FPGA is manufactured, to implement any of the CF features. A hierarchy of programmable interconnects allow logic blocks to be interconnected as needed by the CF system designer/administrator, somewhat like a one-chip programmable breadboard. An FPGA's logic blocks can be programmed to perform the operation of basic logic gates such as AND, and XOR, or more complex combinational operators such as decoders or simple mathematical operations. In most FPGAs, the logic blocks also include memory elements, which may be circuit flip-flops or more complete blocks of memory. In some circumstances, the CF may be developed on regular FPGAs and then migrated into a fixed version that more resembles ASIC implementations. Alternate or coordinating implementations may migrate CF controller features to a final ASIC instead of or in addition to FPGAs. Depending on the implementation all of the aforementioned embedded components and microprocessors may be considered the “CPU” and/or “processor” for the CF.

### Power Source

The power source 686 may be of any standard form for powering small electronic circuit board devices such as the following power cells: alkaline, lithium hydride, lithium ion, lithium polymer, nickel cadmium, solar cells, and/or the like. Other types of AC or DC power sources may be used as well. In the case of solar cells, in one embodiment, the case provides an aperture through which the solar cell may capture photonic energy. The power cell 686 is connected to at least one of the interconnected subsequent components of the CF thereby providing an electric current to all the interconnected components. In one example, the power source 686 is connected to the system bus component 604. In an alternative embodiment, an outside power source 686 is provided through a connection across the I/O 608 interface. For example, a USB and/or IEEE 1394 connection carries both data and power across the connection and is therefore a suitable source of power.

### Interface Adapters

Interface bus(ses) 607 may accept, connect, and/or communicate to a number of interface adapters, frequently, although not necessarily in the form of adapter cards, such as but not limited to: input output interfaces (I/O) 608, storage interfaces 609, network interfaces 610, and/or the like. Optionally, cryptographic processor interfaces 627 similarly may be connected to the interface bus. The interface bus provides for the communications of interface adapters with one another as well as with other components of the computer systemization. Interface adapters are adapted for a compatible interface bus. Interface adapters may connect to the interface bus via expansion and/or slot architecture. Various expansion and/or slot architectures may be employed, such as, but not limited to: Accelerated Graphics Port (AGP), Card Bus, ExpressCard, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), Thunderbolt, and/or the like.

Storage interfaces 609 may accept, communicate, and/or connect to a number of storage devices such as, but not limited to: storage devices 614, removable disc devices, and/or the like. Storage interfaces may employ connection protocols such as, but not limited to: (Ultra) (Serial) Advanced Technology Attachment (Packet Interface) ((Ultra) (Serial) ATA(PI)), (Enhanced) Integrated Drive Electronics ((E)IDE), Institute of Electrical and Electronics Engineers (IEEE) 1394, Ethernet, fiber channel, Small Computer Systems Interface (SCSI), Thunderbolt, Universal Serial Bus (USB), and/or the like.

Network interfaces 610 may accept, communicate, and/or connect to a communications network 613. Through a communications network 613, the CF controller is accessible through remote clients 633b (e.g., computers with web browsers) by users 633a. Network interfaces may employ connection protocols such as, but not limited to: direct connect, Ethernet (thick, thin, twisted pair 10/100/1000 Base T, and/or the like), Token Ring, wireless connection such as IEEE 802.11a-x, and/or the like. Should processing requirements dictate a greater amount speed and/or capacity, distributed network controllers (e.g., Distributed CF), architectures may similarly be employed to pool, load balance, and/or otherwise increase the communicative bandwidth required by the CF controller. A communications network may be any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. A network interface may be regarded as a specialized form of an input output interface. Further, multiple network interfaces 610 may be used to engage with various communications network types 613. For example, multiple network interfaces may be employed to allow for the communication over broadcast, multicast, and/or unicast networks.

Input Output interfaces (I/O) 608 may accept, communicate, and/or connect to user input devices 611, peripheral devices 612, cryptographic processor devices 628, and/or the like. I/O may employ connection protocols such as, but not limited to: audio: analog, digital, monaural, RCA, stereo, and/or the like; data: Apple Desktop Bus (ADB), Bluetooth, IEEE 1394a-b, serial, universal serial bus (USB); infrared; joystick; keyboard; midi; optical; PC AT; PS/2; parallel; radio; video interface: Apple Desktop Connector (ADC), BNC, coaxial, component, composite, digital, DisplayPort, Digital Visual Interface (DVI), high-definition multimedia interface (HDMI), RCA, RF antennae, S-Video, VGA, and/or the like; wireless transceivers: 802.11a/b/g/n/x, Bluetooth; cellular (e.g., code division multiple access (CDMA), high speed packet access (HSPA(+)), high-speed downlink packet access (HSDPA), global system for mobile communications (GSM), long term evolution (LTE), WiMax, etc.); and/or the like. One output device may be a video display, which may take the form of a Cathode Ray Tube (CRT), Liquid Crystal Display (LCD), Light Emitting Diode (LED), Organic Light Emitting Diode (OLED), Plasma, and/or the like based monitor with an interface (e.g., VGA, DVI circuitry and cable) that accepts signals from a video interface. The video interface composites information generated by a computer systemization and generates video signals based on the composited information in a video memory frame. Another output device is a television set, which accepts signals from a video interface. Often, the video interface provides the composited video information through a video connection interface that accepts a video display interface (e.g., an RCA composite video connector accepting an RCA composite video cable; a DVI connector accepting a DVI display cable, HDMI, etc.).

User input devices 611 often are a type of peripheral device 612 (see below) and may include: card readers, dongles, finger print readers, gloves, graphics tablets, joysticks, keyboards, microphones, mouse (mice), remote controls, retina readers, touch screens (e.g., capacitive, resistive, etc.), trackballs, trackpads, sensors (e.g., accelerometers, ambient light, GPS, gyroscopes, proximity, etc.), styluses, and/or the like.

Peripheral devices 612 may be connected and/or communicate to I/O and/or other facilities of the like such as network interfaces, storage interfaces, directly to the interface bus, system bus, the CPU, and/or the like. Peripheral devices may be external, internal and/or part of the CF controller. Peripheral devices may include: antenna, audio devices (e.g., line-in, line-out, microphone input, speakers, etc.), cameras (e.g., still, video, webcam, etc.), dongles (e.g., for copy protection, ensuring secure transactions with a digital signature, and/or the like), external processors (for added capabilities; e.g., crypto devices 628), force-feedback devices (e.g., vibrating motors), near field communication (NFC) devices, network interfaces, printers, radio frequency identifiers (RFIDs), scanners, storage devices, transceivers (e.g., cellular, GPS, etc.), video devices (e.g., goggles, monitors, etc.), video sources, visors, and/or the like. Peripheral devices often include types of input devices (e.g., microphones, cameras, etc.).

It should be noted that although user input devices and peripheral devices may be employed, the CF controller may be embodied as an embedded, dedicated, and/or monitor-less (i.e., headless) device, wherein access would be provided over a network interface connection.

Cryptographic units such as, but not limited to, microcontrollers, processors 626, interfaces 627, and/or devices 628 may be attached, and/or communicate with the CF controller. A MC68HC16 microcontroller, manufactured by Motorola Inc., may be used for and/or within cryptographic units. The MC68HC16 microcontroller utilizes a 16-bit multiply-and-accumulate instruction in the 16 MHz configuration and requires less than one second to perform a 512-bit RSA private key operation. Cryptographic units support the authentication of communications from interacting agents, as well as allowing for anonymous transactions. Cryptographic units may also be configured as part of the CPU. Equivalent microcontrollers and/or processors may also be used. Other commercially available specialized cryptographic processors include: the Broadcom's CryptoNetX and other Security Processors; nCipher's nShield (e.g., Solo, Connect, etc.), SafeNet's Luna PCI (e.g., 7100) series; Semaphore Communications' 40 MHz Roadrunner 184; sMIP's (e.g., 208956); Sun's Cryptographic Accelerators (e.g., Accelerator 6000 PCIe Board, Accelerator 500 Daughtercard); Via Nano Processor (e.g., L2100, L2200, U2400) line, which is capable of performing 500+MB/s of cryptographic instructions; VLSI Technology's 33 MHz 6868; and/or the like.

### Memory

Generally, any mechanization and/or embodiment allowing a processor to affect the storage and/or retrieval of information is regarded as memory 629. However, memory is a fungible technology and resource, thus, any number of memory embodiments may be employed in lieu of or in concert with one another. It is to be understood that the CF controller and/or a computer systemization may employ various forms of memory 629. For example, a computer systemization may be configured wherein the operation of on-chip CPU memory (e.g., registers), RAM, ROM, and any other storage devices are provided by a paper punch tape or paper punch card mechanism; however, such an embodiment would result in an extremely slow rate of operation. In one configuration, memory 629 may include ROM 606, RAM 605, and a storage device 614. A storage device 614 may employ any number of computer storage devices/systems. Storage devices may include a drum; a (fixed and/or removable) magnetic disk drive; a magneto-optical drive; an optical drive (i.e., Blueray, CD ROM/RAM/Recordable (R)/ReWritable (RW), DVD R/RW, HD DVD R/RW etc.); an array of devices (e.g., Redundant Array of Independent Disks (RAID)); solid state memory devices (USB memory, solid state drives (SSD), etc.); other processor-readable storage mediums; and/or other devices of the like. Thus, a computer systemization generally requires and makes use of memory.

### Component Collection

The memory 629 may contain a collection of program and/or database components and/or data such as, but not limited to: operating system component(s) 615 (operating system); information server component(s) 616 (information server); user interface component(s) 617 (user interface); Web browser component(s) 618 (Web browser); database(s) 619; mail server component(s) 621; mail client component(s) 622; cryptographic server component(s) 620 (cryptographic server); the CF component(s) 635; and/or the like (i.e., collectively a component collection). These components may be stored and accessed from the storage devices and/or from storage devices accessible through an interface bus. Although non-conventional program components such as those in the component collection may be stored in a local storage device 614, they may also be loaded and/or stored in memory such as: peripheral devices, RAM, remote storage facilities through a communications network, ROM, various forms of memory, and/or the like.

### Operating System

The operating system component 615 is an executable program component facilitating the operation of the CF controller. The operating system may facilitate access of I/O, network interfaces, peripheral devices, storage devices, and/or the like. The operating system may be a highly fault tolerant, scalable, and secure system such as: Apple Macintosh OS X (Server); AT&T Nan 9; Be OS; Unix and Unix-like system distributions (such as AT&T's UNIX; Berkley Software Distribution (BSD) variations such as FreeBSD, NetBSD, OpenBSD, and/or the like; Linux distributions such as Red Hat, Ubuntu, and/or the like); and/or the like operating systems. However, more limited and/or less secure operating systems also may be employed such as Apple Macintosh OS, IBM OS/2, Microsoft DOS, Microsoft Windows 2000/2003/3.1/95/98/CE/Millennium/NT/Vista/XP (Server), Palm OS, and/or the like. In addition, emobile operating systems such as Apple's iOS, Google's Android, Hewlett Packard's WebOS, Microsofts Windows Mobile, and/or the like may be employed. Any of these operating systems may be embedded within the hardware of the NICK controller, and/or stored/loaded into memory/storage. An operating system may communicate to and/or with other components in a component collection, including itself, and/or the like. Most frequently, the operating system communicates with other program components, user interfaces, and/or the like. For example, the operating system may contain, communicate, generate, obtain, and/or provide program component, system, user, and/or data communications, requests, and/or responses. The operating system, once executed by the CPU, may enable the interaction with communications networks, data, I/O, peripheral devices, program components, memory, user input devices, and/or the like. The operating system may provide communications protocols that allow the CF controller to communicate with other entities through a communications network 613. Various communication protocols may be used by the CF controller as a subcarrier transport mechanism for interaction, such as, but not limited to: multicast, TCP/IP, UDP, unicast, and/or the like.

### Information Server

An information server component 616 is a stored program component that is executed by a CPU. The information server may be an Internet information server such as, but not limited to Apache Software Foundation's Apache, Microsoft's Internet Information Server, and/or the like. The information server may allow for the execution of program components through facilities such as Active Server Page (ASP), ActiveX, (ANSI) (Objective−) C (++), C# and/or .NET, Common Gateway Interface (CGI) scripts, dynamic (D) hypertext markup language (HTML), FLASH, Java, JavaScript, Practical Extraction Report Language (PERL), Hypertext Pre-Processor (PHP), pipes, Python, wireless application protocol (WAP), WebObjects, and/or the like. The information server may support secure communications protocols such as, but not limited to, File Transfer Protocol (FTP); HyperText Transfer Protocol (HTTP); Secure Hypertext Transfer Protocol (HTTPS), Secure Socket Layer (SSL), messaging protocols (e.g., America Online (AOL) Instant Messenger (AIM), Apple's iMessage, Application Exchange (APEX), ICQ, Internet Relay Chat (IRC), Microsoft Network (MSN) Messenger Service, Presence and Instant Messaging Protocol (PRIM), Internet Engineering Task Force's (IETF's) Session Initiation Protocol (SIP), SIP for Instant Messaging and Presence Leveraging Extensions (SIMPLE), open XML-based Extensible Messaging and Presence Protocol (XMPP) (i.e., Jabber or Open Mobile Alliance's (OMA's) Instant Messaging and Presence Service (IMPS)), Yahoo! Instant Messenger Service, and/or the like. The information server provides results in the form of Web pages to Web browsers, and allows for the manipulated generation of the Web pages through interaction with other program components. After a Domain Name System (DNS) resolution portion of an HTTP request is resolved to a particular information server, the information server resolves requests for information at specified locations on the CF controller based on the remainder of the HTTP request. For example, a request such as http://123.124.125.126/myInformation.html might have the IP portion of the request “123.124.125.126” resolved by a DNS server to an information server at that IP address; that information server might in turn further parse the http request for the “/myInformation.html” portion of the request and resolve it to a location in memory containing the information “myInformation.html.” Additionally, other information serving protocols may be employed across various ports, e.g., FTP communications across port 21, and/or the like. An information server may communicate to and/or with other components in a component collection, including itself, and/or facilities of the like. Most frequently, the information server communicates with the CF database 619, operating systems, other program components, user interfaces, Web browsers, and/or the like.

Access to the CF database may be achieved through a number of database bridge mechanisms such as through scripting languages as enumerated below (e.g., CGI) and through inter-application communication channels as enumerated below (e.g., CORBA, WebObjects, etc.). Any data requests through a Web browser are parsed through the bridge mechanism into appropriate grammars as required by the CF. In one embodiment, the information server would provide a Web form accessible by a Web browser. Entries made into supplied fields in the Web form are tagged as having been entered into the particular fields, and parsed as such. The entered terms are then passed along with the field tags, which act to instruct the parser to generate queries directed to appropriate tables and/or fields. In one embodiment, the parser may generate queries in standard SQL by instantiating a search string with the proper join/select commands based on the tagged text entries, wherein the resulting command is provided over the bridge mechanism to the CF as a query. Upon generating query results from the query, the results are passed over the bridge mechanism, and may be parsed for formatting and generation of a new results Web page by the bridge mechanism. Such a new results Web page is then provided to the information server, which may supply it to the requesting Web browser.

Also, an information server may contain, communicate, generate, obtain, and/or provide program component, system, user, and/or data communications, requests, and/or responses.

### User Interface

Computer interfaces in some respects are similar to automobile operation interfaces. Automobile operation interface elements such as steering wheels, gearshifts, and speedometers facilitate the access, operation, and display of automobile resources, and status. Computer interaction interface elements such as check boxes, cursors, menus, scrollers, and windows (collectively and commonly referred to as widgets) similarly facilitate the access, capabilities, operation, and display of data and computer hardware and operating system resources, and status. Operation interfaces are commonly called user interfaces. Graphical user interfaces (GUIs) such as the Apple Macintosh Operating System's Aqua and iOS's Cocoa Touch, IBM's OS/2, Google's Android Mobile UI, Microsoft's Windows 2000/2003/3.1/95/98/CE/Millennium/15 Mobile/NT/XP/Vista/7/8 (i.e., Aero, Metro), Unix's X-Windows (e.g., which may include additional Unix graphic interface libraries and layers such as K Desktop Environment (KDE), mythTV and GNU Network Object Model Environment (GNOME)), web interface libraries (e.g., ActiveX, AJAX, (D)HTML, FLASH, Java, JavaScript, etc. interface libraries such as, but not limited to, Dojo, jQuery(UI), MooTools, Prototype, script.aculo.us, SWFObject, Yahoo! User Interface, any of which may be used and) provide a baseline and means of accessing and displaying information graphically to users.

A user interface component 617 is a stored program component that is executed by a CPU. The user interface may be a graphic user interface as provided by, with, and/or atop operating systems and/or operating environments such as already discussed. The user interface may allow for the display, execution, interaction, manipulation, and/or operation of program components and/or system facilities through textual and/or graphical facilities. The user interface provides a facility through which users may affect, interact, and/or operate a computer system. A user interface may communicate to and/or with other components in a component collection, including itself, and/or facilities of the like. Most frequently, the user interface communicates with operating systems, other program components, and/or the like. The user interface may contain, communicate, generate, obtain, and/or provide program component, system, user, and/or data communications, requests, and/or responses.

### Web Browser

A Web browser component 618 is a stored program component that is executed by a CPU. The Web browser may be a hypertext viewing application such as Google's (Mobile) Chrome, Microsoft Internet Explorer, Netscape Navigator, Apple's (Mobile) Safari, embedded web browser objects such as through Apple's Cocoa (Touch) object class, and/or the like. Secure Web browsing may be supplied with 128 bit (or greater) encryption by way of HTTPS, SSL, and/or the like. Web browsers allowing for the execution of program components through facilities such as ActiveX, AJAX, (D)HTML, FLASH, Java, JavaScript, web browser plug-in APIs (e.g., Chrome, FireFox, Internet Explorer, Safari Plug-in, and/or the like APIs), and/or the like. Web browsers and like information access tools may be integrated into PDAs, cellular telephones, smartphones, and/or other mobile devices. A Web browser may communicate to and/or with other components in a component collection, including itself, and/or facilities of the like. Most frequently, the Web browser communicates with information servers, operating systems, integrated program components (e.g., plug-ins), and/or the like; e.g., it may contain, communicate, generate, obtain, and/or provide program component, system, user, and/or data communications, requests, and/or responses. Also, in place of a Web browser and information server, a combined application may be developed to perform similar operations of both. The combined application would similarly effect the obtaining and the provision of information to users, user agents, and/or the like from the CF equipped nodes. The combined application may be nugatory on systems employing standard Web browsers.

### Mail Server

A mail server component 621 is a stored program component that is executed by a CPU 603. The mail server may be an Internet mail server such as, but not limited to Apple's Mail Server (3), dovect, sendmail, Microsoft Exchange, and/or the like. The mail server may allow for the execution of program components through facilities such as ASP, ActiveX, (ANSI) (Objective−) C (++), C# and/or .NET, CGI scripts, Java, JavaScript, PERL, PHP, pipes, Python, WebObjects, and/or the like. The mail server may support communications protocols such as, but not limited to: Internet message access protocol (IMAP), Messaging Application Programming Interface (MAPI)/Microsoft Exchange, post office protocol (POP3), simple mail transfer protocol (SMTP), and/or the like. The mail server can route, forward, and process incoming and outgoing mail messages that have been sent, relayed and/or otherwise traversing through and/or to the CF.

Access to the CF mail may be achieved through a number of APIs offered by the individual Web server components and/or the operating system.

Also, a mail server may contain, communicate, generate, obtain, and/or provide program component, system, user, and/or data communications, requests, information, and/or responses.

### Mail Client

A mail client component 622 is a stored program component that is executed by a CPU 603. The mail client may be a mail viewing application such as Apple (Mobile) Mail, Microsoft Entourage, Microsoft Outlook, Microsoft Outlook Express, Mozilla, Thunderbird, and/or the like. Mail clients may support a number of transfer protocols, such as: IMAP, Microsoft Exchange, POP3, SMTP, and/or the like. A mail client may communicate to and/or with other components in a component collection, including itself, and/or facilities of the like. Most frequently, the mail client communicates with mail servers, operating systems, other mail clients, and/or the like; e.g., it may contain, communicate, generate, obtain, and/or provide program component, system, user, and/or data communications, requests, information, and/or responses. Generally, the mail client provides a facility to compose and transmit electronic mail messages.

### Cryptographic Server

A cryptographic server component 620 is a stored program component that is executed by a CPU 603, cryptographic processor 626, cryptographic processor interface 627, cryptographic processor device 628, and/or the like. Cryptographic processor interfaces will allow for expedition of encryption and/or decryption requests by the cryptographic component; however, the cryptographic component, alternatively, may run on a CPU. The cryptographic component allows for the encryption and/or decryption of provided data. The cryptographic component allows for both symmetric and asymmetric (e.g., Pretty Good Protection (PGP)) encryption and/or decryption. The cryptographic component may employ cryptographic techniques such as, but not limited to: digital certificates (e.g., X.509 authentication framework), digital signatures, dual signatures, enveloping, password access protection, public key management, and/or the like. The cryptographic component will facilitate numerous (encryption and/or decryption) security protocols such as, but not limited to: checksum, Data Encryption Standard (DES), Elliptical Curve Encryption (ECC), International Data Encryption Algorithm (IDEA), Message Digest 5 (MD5, which is a one way hash operation), passwords, Rivest Cipher (RC5), Rijndael, RSA (which is an Internet encryption and authentication system that uses an algorithm developed in 1977 by Ron Rivest, Adi Shamir, and Leonard Adleman), Secure Hash Algorithm (SHA), Secure Socket Layer (SSL), Secure Hypertext Transfer Protocol (HTTPS), and/or the like. Employing such encryption security protocols, the CF may encrypt all incoming and/or outgoing communications and may serve as node within a virtual private network (VPN) with a wider communications network. The cryptographic component facilitates the process of “security authorization” whereby access to a resource is inhibited by a security protocol wherein the cryptographic component effects authorized access to the secured resource. In addition, the cryptographic component may provide unique identifiers of content, e.g., employing and MD5 hash to obtain a unique signature for an digital audio file. A cryptographic component may communicate to and/or with other components in a component collection, including itself, and/or facilities of the like. The cryptographic component supports encryption schemes allowing for the secure transmission of information across a communications network to enable the CF component to engage in secure transactions if so desired. The cryptographic component facilitates the secure accessing of resources on the CF and facilitates the access of secured resources on remote systems; i.e., it may act as a client and/or server of secured resources. Most frequently, the cryptographic component communicates with information servers, operating systems, other program components, and/or the like. The cryptographic component may contain, communicate, generate, obtain, and/or provide program component, system, user, and/or data communications, requests, and/or responses.

### The CF Database

The CF database component 619 may be embodied in a database and its stored data. The database is a stored program component, which is executed by the CPU; the stored program component portion configuring the CPU to process the stored data. The database may be any of a number of fault tolerant, relational, scalable, secure databases, such as DB2, MySQL, Oracle, Sybase, and/or the like. Relational databases are an extension of a flat file. Relational databases consist of a series of related tables. The tables are interconnected via a key field. Use of the key field allows the combination of the tables by indexing against the key field; i.e., the key fields act as dimensional pivot points for combining information from various tables. Relationships generally identify links maintained between tables by matching primary keys. Primary keys represent fields that uniquely identify the rows of a table in a relational database. More precisely, they uniquely identify rows of a table on the “one” side of a one-to-many relationship.

Alternatively, the CF database may be implemented using various standard data-structures, such as an array, hash, (linked) list, struct, structured text file (e.g., XML), table, and/or the like. Such data-structures may be stored in memory and/or in (structured) files. In another alternative, an object-oriented database may be used, such as Frontier, ObjectStore, Poet, Zope, and/or the like. Object databases can include a number of object collections that are grouped and/or linked together by common attributes; they may be related to other object collections by some common attributes. Object-oriented databases perform similarly to relational databases with the exception that objects are not just pieces of data but may have other types of capabilities encapsulated within a given object. If the CF database is implemented as a data-structure, the use of the CF database 619 may be integrated into another component such as the CF component 635. Also, the database may be implemented as a mix of data structures, objects, and relational structures. Databases may be consolidated and/or distributed in countless variations through standard data processing techniques. Portions of databases, e.g., tables, may be exported and/or imported and thus decentralized and/or integrated.

In one embodiment, the database component 619 includes several tables 619a-o. A Users table 619a may include fields such as, but not limited to: user_id, ssn, dob, first_name, last_name, age, state, address_firstline, address_secondline, zipcode, devices_list, contact_info, contact_type, alt contact_info, alt contact_type, and/or the like. The Users table may support and/or track multiple entity accounts on a CF. A Devices table 619b may include fields such as, but not limited to: device_ID, device_name, device_IP, device_GPS, device_MAC, device_serial, device_ECID, device_UDID, device_browser, device_type, device_model, device_version, device_OS, device_apps list, device_securekey, wallet_app_installed_flag, and/or the like. An Apps table 619c may include fields such as, but not limited to: app_ID, app_name, app_type, app_dependencies, app_access_code, user_pin, and/or the like. An Accounts table 619d may include fields such as, but not limited to: account_number, account security code, account_name, issuer acquirer_flag, issuer_name, acquirer_name, account_address, routing_number, access_API_call, linked_wallets_list, and/or the like. A Bids table 619e may include fields such as, but not limited to: bid_id, user_id, requestor_id, bid_amount, bid_type, bid_expiry, bid_timestamp, bid_detail, and/or the like. An Asks table 619f may include fields such as, but not limited to: ask_id, user_id, requestor_id, ask_amount, ask_type, ask_expiry, ask_timestamp, ask_detail, and/or the like. A Requests table 619g may include fields such as, but not limited to: request_id, user_id, requestor_id, request_amount, request_type, request_expiry, request_timestamp, request_detail, cargo_type, cargo_description, cargo_insurance, cargo_weight, cargo_armor, cargo_fragile_flag, cargo_perishable_flag, and/or the like. An Insurance table 619h may include fields such as, but not limited to: cargo_id, cargo_type, coverage_type, coverage_amount, coverage_term, insurance_premium, insurance_pay detail, and/or the like. A Maps table 619i may include fields such as, but not limited to: map_id, map_type, map_layers_list, maps_layer_data, maps_filters_list, maps_parameters_list, and/or the like. A Matching Parameters table 619j may include fields such as, but not limited to: order_id, user_id, timestamp, transaction_cost, purchase_details_list, num_products, products_list, product_type, product_params_list, product_title, product_summary, quantity, user_id, client_id, client_ip, client_type, client_model, operating_system, os_version, app_installed_flag, user_id, account_firstname, account_lastname, account_type, account_num, account_priority_account_ratio, billingaddress_line1, billingaddress_line2, billing_zipcode, billing_state, shipping_preferences, shippingaddress_line1, shippingaddress_line2, shipping_{—} zipcode, shipping_state, merchant_id, merchant_name, merchant_auth_key, request_id, user_id, requestor_id, request_amount, request_type, request_expiry, request_timestamp, request_detail, cargo_type, cargo_description, cargo_insurance, cargo_weight, cargo_armor, cargo_fragile_flag, cargo_perishable_flag, and/or the like. An Orders table 619k may include fields such as, but not limited to: order_id, transaction_id_list, timestamp_list, complete_flag, request_id, user_id, requestor_id, request_amount, request_type, request_expiry, request_timestamp, request_detail, cargo_type, cargo_description, cargo_insurance, cargo_weight, cargo_armor, cargo_fragile_flag, cargo_perishable_flag, and/or the like. A Cargo table 619l may include fields such as, but not limited to: request_id, user_id, requestor_id, request_amount, request_type, request_expiry, request_timestamp, request_detail, cargo_type, cargo_description, cargo_insurance, cargo_weight, cargo_armor, cargo_fragile_flag, cargo_perishable_flag, and/or the like. A Payments table 619m may include fields such as, but not limited to: order_id, user_id, timestamp, transaction_cost, purchase_details_list, num_products, products_list, product_type, product_params_list, product_title, product_summary, quantity, user_id, client_id, client_ip, client_type, client_model, operating_system, os_version, app_installed_flag, user_id, account_firstname, account_lastname, account_type, account_num, account_priority_account_ratio, billingaddress_line1, billingaddress_line2, billing_zipcode, billing_state, shipping_preferences, shippingaddress_line1, shippingaddress_line2, shipping_{—} zipcode, shipping_state, merchant_id, merchant_name, merchant_auth_key, and/or the like. An Social table 619n may include fields such as, but not limited to: user_id, user_graph list, user_conv_data, and/or the like. A Compliance table 6190 may include fields such as, but not limited to: user_id, timestamp, activity_type, activity_location, activity_attribute list, activity_attribute_values_list, and/or the like.

In one embodiment, the CF database may interact with other database systems. For example, employing a distributed database system, queries and data access by search CF component may treat the combination of the CF database, an integrated data security layer database as a single database entity.

In one embodiment, user programs may contain various user interface primitives, which may serve to update the CF. Also, various accounts may require custom database tables depending upon the environments and the types of clients the CF may need to serve. It should be noted that any unique fields may be designated as a key field throughout. In an alternative embodiment, these tables have been decentralized into their own databases and their respective database controllers (i.e., individual database controllers for each of the above tables). Employing standard data processing techniques, one may further distribute the databases over several computer systemizations and/or storage devices. Similarly, configurations of the decentralized database controllers may be varied by consolidating and/or distributing the various database components 619a-o. The CF may be configured to keep track of various settings, inputs, and parameters via database controllers.

The CF database may communicate to and/or with other components in a component collection, including itself, and/or facilities of the like. Most frequently, the CF database communicates with the CF component, other program components, and/or the like. The database may contain, retain, and provide information regarding other nodes and data.

### The CFs

The CF component 635 is a stored program component that is executed by a CPU. In one embodiment, the CF component incorporates any and/or all combinations of the aspects of the CF discussed in the previous figures. As such, the CF affects accessing, obtaining and the provision of information, services, transactions, and/or the like across various communications networks. The features and embodiments of the CF discussed herein increase network efficiency by reducing data transfer requirements the use of more efficient data structures and mechanisms for their transfer and storage. As a consequence, more data may be transferred in less time, and latencies with regard to transactions, are also reduced. In many cases, such reduction in storage, transfer time, bandwidth requirements, latencies, etc., will reduce the capacity and structural infrastructure requirements to support the CF's features and facilities, and in many cases reduce the costs, energy consumption/requirements, and extend the life of CF's underlying infrastructure; this has the added benefit of making the CF more reliable. Similarly, many of the features and mechanisms are designed to be easier for users to use and access, thereby broadening the audience that may enjoy/employ and exploit the feature sets of the CF; such ease of use also helps to increase the reliability of the CF. In addition, the feature sets include heightened security as noted via the Cryptographic components 620, 626, 628 and throughout, making access to the features and data more reliable and secure. The CF component may transform consumer service request input data via CF components into provider service confirmation messages and provider service monitoring triggers, and/or like use of the CF. In one embodiment, the CF component 635 takes inputs (e.g., service request input data 411; profile data 415; responses 418; and/or the like) etc., and transforms the inputs via various components 11 (e.g., p2p-CF 641; COMR 642; Trucking App 643; and/or the like), into outputs (e.g., service offer/requests 413; service offer responses 420; confirmation messages 425; provider service monitoring triggers (see 426); and/or the like).

The CF component enabling access of information between nodes may be developed by employing standard development tools and languages such as, but not limited to: Apache components, Assembly, ActiveX, binary executables, (ANSI) 17 (Objective−) C (++), C# and/or .NET, database adapters, CGI scripts, Java, JavaScript, mapping tools, procedural and object oriented development tools, PERL, PHP, Python, shell scripts, SQL commands, web application server extensions, web development environments and libraries (e.g., Microsoft's ActiveX; Adobe AIR, FLEX & FLASH; AJAX; (D)HTML; Dojo, Java; JavaScript; jQuery(UI); MooTools; Prototype; script.aculo.us; Simple Object Access Protocol (SOAP); SWFObject; Yahoo! User Interface; and/or the like), WebObjects, and/or the like. In one embodiment, the CF server employs a cryptographic server to encrypt and decrypt communications. The CF component may communicate to and/or with other components in a component collection, including itself, and/or facilities of the like. Most frequently, the CF component communicates with the CF database, operating systems, other program components, and/or the like. The CF may contain, communicate, generate, obtain, and/or provide program component, system, user, and/or data communications, requests, and/or responses.

### Distributed CFs

The structure and/or operation of any of the CF node controller components may be combined, consolidated, and/or distributed in any number of ways to facilitate development and/or deployment. Similarly, the component collection may be combined in any number of ways to facilitate deployment and/or development. To accomplish this, one may integrate the components into a common code base or in a facility that can dynamically load the components on demand in an integrated fashion.

The component collection may be consolidated and/or distributed in countless variations through standard data processing and/or development techniques. Multiple instances of any one of the program components in the program component collection may be instantiated on a single node, and/or across numerous nodes to improve performance through load-balancing and/or data-processing techniques. Furthermore, single instances may also be distributed across multiple controllers and/or storage devices; e.g., databases. All program component instances and controllers working in concert may do so through standard data processing communication techniques.

The configuration of the CF controller will depend on the context of system deployment. Factors such as, but not limited to, the budget, capacity, location, and/or use of the underlying hardware resources may affect deployment requirements and configuration. Regardless of if the configuration results in more consolidated and/or integrated program components, results in a more distributed series of program components, and/or results in some combination between a consolidated and distributed configuration, data may be communicated, obtained, and/or provided. Instances of components consolidated into a common code base from the program component collection may communicate, obtain, and/or provide data. This may be accomplished through intra-application data processing communication techniques such as, but not limited to: data referencing (e.g., pointers), internal messaging, object instance variable communication, shared memory space, variable passing, and/or the like.

If component collection components are discrete, separate, and/or external to one another, then communicating, obtaining, and/or providing data with and/or to other components may be accomplished through inter-application data processing communication techniques such as, but not limited to: Application Program Interfaces (API) information passage; (distributed) Component Object Model ((D)COM), (Distributed) Object Linking and Embedding ((D)OLE), and/or the like), Common Object Request Broker Architecture (CORBA), Jini local and remote application program interfaces, JavaScript Object Notation (JSON), Remote Method Invocation (RMI), SOAP, process pipes, shared files, and/or the like. Messages sent between discrete component components for inter-application communication or within memory spaces of a singular component for intra-application communication may be facilitated through the creation and parsing of a grammar. A grammar may be developed by using development tools such as lex, yacc, XML, and/or the like, which allow for grammar generation and parsing capabilities, which in turn may form the basis of communication messages within and between components.

For example, a grammar may be arranged to recognize the tokens of an HTTP post command, e.g.:
w3c-post http:// . . . Value1

where Value1 is discerned as being a parameter because “http://” is part of the grammar syntax, and what follows is considered part of the post value. Similarly, with such a grammar, a variable “Value1” may be inserted into an “http://” post command and then sent. The grammar syntax itself may be presented as structured data that is interpreted and/or otherwise used to generate the parsing mechanism (e.g., a syntax description text file as processed by lex, yacc, etc.). Also, once the parsing mechanism is generated and/or instantiated, it itself may process and/or parse structured data such as, but not limited to: character (e.g., tab) delineated text, HTML, structured text streams, XML, and/or the like structured data. In another embodiment, inter-application data processing protocols themselves may have integrated and/or readily available parsers (e.g., JSON, SOAP, and/or like parsers) that may be employed to parse (e.g., communications) data. Further, the parsing grammar may be used beyond message parsing, but may also be used to parse: databases, data collections, data stores, structured data, and/or the like. Again, the desired configuration will depend upon the context, environment, and requirements of system deployment.

For example, in some implementations, the CF controller may be executing a PHP script implementing a Secure Sockets Layer (“SSL”) socket server via the information server, which listens to incoming communications on a server port to which a client may send data, e.g., data encoded in JSON format. Upon identifying an incoming communication, the PHP script may read the incoming message from the client device, parse the received JSON-encoded text data to extract information from the JSON-encoded text data into PHP script variables, and store the data (e.g., client identifying information, etc.) and/or extracted information in a relational database accessible using the Structured Query Language (“SQL”). An exemplary listing, written substantially in the form of PHP/SQL commands, to accept JSON-encoded input data from a client device via a SSL connection, parse the data to extract variables, and store the data to a database, is provided below:

```
<?PHP
header(‘Content-Type: text/plain’);
// set ip address and port to listen to for incoming data
$address = ‘192.168.0.100’;
$port = 255;
// create a server-side SSL socket, listen for/accept incoming
communication
$sock = socket_create(AF_INET, SOCK_STREAM, 0);
socket_bind($sock, $address, $port) or die(‘Could not bind to address’);
socket_listen($sock);
$client = socket_accept($sock);
// read input data from client device in 1024 byte blocks until end of
message
do {
    $input = ””;
    $input = socket_read($client, 1024);
    $data .= $input;
} while($input != ””);
// parse data to extract variables
$obj = json_decode($data, true);
// store input data in a database
mysql_connect(″201.408.185.132″,$DBserver,$password); // access
database server
mysql_select(″CLIENT_DB.SQL″); // select database to append
mysql_query(”INSERT INTO UserTable (transmission)
VALUES ($data)”); // add data to UserTable table in  a CLIENT database
mysql_close(″CLIENT_DB.SQL″); // close connection to database
?>
```

Also, the following resources may be used to provide example embodiments regarding SOAP parser implementation:

http://www.xav.com/perl/site/lib/SOAP/Parser.html
http://publib.boulder.ibm.com/infocenter/tivihelp/v2r1/index.jsp?topic=/
com.ibm.IBMDI.doc/referenceguide295.htm

and other parser implementations:

http://publib.boulder.ibm.com/infocenter/tivihelp/v2r1/index.jsp?topic=/
com.ibm.IBMDI.doc/referenceguide259.htm

all of which are hereby expressly incorporated by reference herein.

In order to address various issues and advance the art, the entirety of this application for COMMERCE FACILITATION APPARATUSES, METHODS AND SYSTEMS (including the Cover Page, Title, Headings, Field, Background, Summary, Brief Description of the Drawings, Detailed Description, Claims, Abstract, Figures, Appendices and/or otherwise) shows by way of illustration various example embodiments in which the claimed innovations may be practiced. The advantages and features of the application are of a representative sample of embodiments only, and are not exhaustive and/or exclusive. They are presented only to assist in understanding and teach the claimed principles. It should be understood that they are not representative of all claimed innovations. As such, certain aspects of the disclosure have not been discussed herein. That alternate embodiments may not have been presented for a specific portion of the innovations or that further undescribed alternate embodiments may be available for a portion is not to be considered a disclaimer of those alternate embodiments. It will be appreciated that many of those undescribed embodiments incorporate the same principles of the innovations and others are equivalent. Thus, it is to be understood that other embodiments may be utilized and functional, logical, operational, organizational, structural and/or topological modifications may be made without departing from the scope and/or spirit of the disclosure. As such, all examples and/or embodiments are deemed to be non-limiting throughout this disclosure. Also, no inference should be drawn regarding those embodiments discussed herein relative to those not discussed herein other than it is as such for purposes of reducing space and repetition. For instance, it is to be understood that the logical and/or topological structure of any combination of any data flow sequence(s), program components (a component collection), other components and/or any present feature sets as described in the figures and/or throughout are not limited to a fixed operating order and/or arrangement, but rather, any disclosed order is exemplary and all equivalents, regardless of order, are contemplated by the disclosure. Furthermore, it is to be understood that such features are not limited to serial execution, but rather, any number of threads, processes, processors, services, servers, and/or the like that may execute asynchronously, concurrently, in parallel, simultaneously, synchronously, and/or the like are also contemplated by the disclosure. As such, some of these features may be mutually contradictory, in that they cannot be simultaneously present in a single embodiment. Similarly, some features are applicable to one aspect of the innovations, and inapplicable to others. In addition, the disclosure includes other innovations not presently claimed. Applicant reserves all rights in those presently unclaimed innovations, including the right to claim such innovations, file additional applications, continuations, continuations-in-part, divisions, and/or the like thereof. As such, it should be understood that advantages, embodiments, examples, functional, features, logical, operational, organizational, structural, topological, and/or other aspects of the disclosure are not to be considered limitations on the disclosure as defined by the claims or limitations on equivalents to the claims. It is to be understood that, depending on the particular needs and/or characteristics of a CF individual and/or enterprise user, database configuration and/or relational model, data type, data transmission and/or network framework, syntax structure, and/or the like, various embodiments of the CF may be implemented that allow a great deal of flexibility and customization. For example, aspects of the CF may be adapted for sales of any commodity, product, or service, organization of workforces, logistics, etc. While various embodiments and discussions of the CF have been directed to facilitating trade and commerce, however, it is to be understood that the embodiments described herein may be readily configured and/or customized for a wide variety of other applications and/or implementations.

What is claimed is:

1. A commerce facilitation processor-implemented method, comprising:
obtaining a peer-to-peer service offer request from a customer device at a service provider device;
obtaining from a database a service provider profile for evaluating the obtained service offer request;
generating a commerce offer match rating for the service offer request at the service provider device;
displaying the commerce offer match rating for a service provider user;
obtaining a service provider user input from the service provider user, in response to displaying the commerce offer match rating;
generating a counter-bid to the obtained service offer request; and
providing the generated counter-bid to the customer device in response to the service offer request.

2. A commerce facilitating system, comprising:
a processor; and
a memory disposed in communication with the processor and storing processor-issuable instructions that cause the processor to generate a graphical user interface that is display via a display screen operatively connected to the processor, the user interface including a map visualization comprising:
a graphical element depicting a location of a service provider;
graphical elements depicting locations of a plurality of potential customers for the service provider; and
a graphical element depicting a fitness for the service provider conducting commerce with one of the potential customers, compared to the other potential customers.
